(19) United States
(12) Patent Application Publication
(10) Pub. No.: US 2006/0175969 A1
(43) Pub. Date: Aug. 10, 2006

(54) Plasma display apparatus, plasma display panel, and manufacturing method of plasma display panel

(76) Inventors: Bum Jin Bae, Yongin-si (KR); Won Seok Moon, Seoul (KR); Jin Hee Jeong, Seongnam-si (KR); Sung Chun Choi, Anyang-si (KR); Je Seok Kim, Anyang-si (KR); Byung Gil Ryu, Seoul (KR)

Correspondence Address: MCKENNA LONG & ALDRIDGE LLP;Song K. Jung, 1900 K Street, N.W., Washington, DC, 20006, US

(21) Appl. No.: 11/319,097

(22) Filed: Dec. 28, 2005

(30) Foreign Application Priority Data
Feb. 7, 2005 (KR) 10-2005-0011254
Feb. 23, 2005 (KR) 10-2005-0014959
Apr. 14, 2005 (KR) 10-2005-0031211
Apr. 14, 2005 (KR) 10-2005-0031208
Apr. 14, 2005 (KR) 10-2005-0031210

(51) Int. Cl. H01J 17/49

(52) U.S. Cl. 313/582

(57) ABSTRACT

A plasma display apparatus, a plasma display panel, and a manufacturing method of the plasma display panel are provided. The plasma display panel comprises a row barrier rib partitioning adjacent cells having the same phosphor coated, and having a groove at its top and a column barrier rib intersecting with the row barrier rib.

This Nonprovisional application claims priority under 35 U.S.C. § 119(a) on Patent Application Nos. 2005-11254, 2005-14959, 2005-31211, 2005-31208, and 2005-31210 filed in Korea on Feb. 7, 2005, Feb. 23, 2005, Apr. 14, 2005, Apr. 14, 2005, and Apr. 14, 2005, the entire contents of which are hereby incorporated by reference.

### BACKGROUND OF THE INVENTION

1. Field of the Invention

The present invention relates to a plasma display apparatus, a plasma display panel and a manufacturing method of the plasma display panel.

2. Description of the Background Art

In a conventional plasma display panel, one unit cell is provided at a space between barrier ribs formed between a front panel and a rear panel. A main discharge gas such as neon (Ne), helium (He) or a mixture (He+Ne) of neon and helium and an inert gas containing a small amount of xenon (Xe) are filled in each cell. When a discharge is performed by using a high frequency voltage, the inert gas generates vacuum ultraviolet rays and phosphors provided between the barrier ribs are emitted, thereby realizing an image. The plasma display panel is considered a next generation display due to its slim profile and brightness weight.

FIG. 1 illustrates a structure of a conventional plasma display panel.

As shown in FIG. 1, a plasma display panel comprises a front panel 100 and a rear panel 110. The front panel 100 has a plurality of sustain electrode pairs arranged with a scan electrode 102 and a sustain electrode 103 each paired and formed on a front glass 101, which is a display surface for displaying the image thereon. The rear panel 110 has a plurality of address electrodes 113 arranged to intersect with the plurality of sustain electrode pairs on a rear glass 111, which is spaced apart in parallel with and sealed to the front panel 100.

The front panel 100 comprises the paired scan electrode 102 and the paired sustain electrode 103 for performing a mutual discharge in one pixel and sustaining emission of light, that is, the paired scan electrode 102 and the paired sustain electrode 103 each having a transparent electrode (a) formed of indium-tin-oxide (ITO) and a bus electrode (b) formed of metal. The scan electrode 102 and the sustain electrode 103 are covered with at least one dielectric layer 104, which controls a discharge current and insulates the paired electrodes. A protective layer 105 is formed of oxide magnesium (MgO) on the dielectric layer 104 to facilitate a discharge condition.

The rear panel 110 comprises stripe-type (or well-type) barrier ribs 112 for forming a plurality of discharge spaces (that is, discharge cells) that are arranged in parallel. Also, the rear panel 110 also comprises a plurality of address electrodes 113 arranged in parallel with the barrier ribs 112, and performing an address discharge and generating the vacuum ultraviolet rays. Red (R), green (G), blue (B) phosphors 114 emit visible rays for displaying the image in the address discharge, and are coated over an upper surface of the rear panel 110. Lower dielectric layer 115 for protecting the address electrode 113 is formed between the address electrode 113 and the phosphor 114.

A black color layer 116 is arranged on the barrier rib 112 to absorb external light from the exterior of the front glass 101, to reduce reflection, and to improve the color purity and contrast of the front glass 101.

In the above-constructed conventional plasma display panel, the barrier rib 112 for forming the plurality of discharge spaces, that is, discharge cells on the rear panel is classified into a stripe type and a well type depending on the structure of the discharge cell. The choice of structure of the barrier rib 112 is determined on the basis of the desired luminance characteristic, exhaust characteristic, and the phosphor coating area.

FIGS. 2 to 4 illustrate the conventional barrier rib structures of the conventional plasma display panels.

FIG. 2 illustrates a stripe type structure where the barrier rib 112 is arranged in a row on the dielectric layer 115 formed on the rear glass 111, and the barrier rib 112 is arranged vertically to a sustain electrode (not shown) and a scan electrode (not shown) comprised of a bus electrode and a transparent electrode. In the stripe type structured barrier rib, the bus electrode is exposed to the discharge space. The bus electrode performs a mutual operation with the address electrode 113 of the rear glass 111. The process to manufacture the bus electrode is uncomplicated. However, there is a drawback in that visible rays generated during a discharge leak into a stripe direction of the barrier rib. Phophsor printing and exhausting are easily performed, but there is a drawback in that erroneous discharges are generated, thereby adversely effecting adjacent cells. Also light emission efficiency is low due to the small size of the phosphor coating area.

FIG. 3 illustrates a well type structure where the barrier rib 112 is formed on the lower dielectric layer 115 formed on the rear glass 111 to have a lattice shape. As shown in FIG. 3, the barrier rib 112 is arranged horizontally or vertically with a sustain electrode (not shown) and a scan electrode (not shown) comprised of a bus electrode and a transparent electrode. In the well type structured barrier rib structure, luminance can be increased due to a large phosphor coating area in the discharge cell and crosstalk can be prevented in an omni direction. However, problem with the well type barrier rib include a complet manufacturing process and impure gas that is not easily exhausted to the exterior in the exhausting process of the conventional manufacturing method of the plasma display panel.

As shown in FIG. 4, the height difference between a first barrier rib 112a and a second barrier rib 112b partitioning the discharge cell in the conventional well type barrier rib structure improves the exhaust characteristic. However, the conventional well type structured barrier rib has a drawback in that the height of the first barrier rib 112a is different from the height of the second barrier rib 112b, thereby causing noise in the plasma display panel. The noise is caused by vibration of the glass when plasma is generated within the plasma display panel. As shown in FIG. 4, there is a drawback in that because the height of the first and second barrier ribs 112a and 112b are different from each other, a cohesive force between the barrier rib and the glass deteriorates, thereby causing a significant noise. In particular, in a high altitude area, the pressure difference between the exterior and the interior of the plasma display panel decreases, thereby reducing the pressure on the glass from the exterior and therefore, the significant noise occurs. There is another drawback in that the impure gas caused by the firing process of the panel subsequent to the exhausting process adversely effects the functionality of the discharge region, thereby deteriorating the picture quality of the plasma display panel.

The phosphor layer is coated and formed between the barrier ribs of the plasma display panel by using a screen-printing method using a mask or a dispensing method using a dispensing device.

A method for forming the phosphor layer of the plasma display panel by using the screen printing method will be described below. First, a phosphor paste is prepared, and is then printed a plurality of times with the mask between the barrier ribs.

The phosphors expressing either red, green, or blue is printed at each pixel region and printing is repeated several times to form the phosphor layer having a suitable thickness and uniformity. In other words, after the printing is concurrently performed for all pixel regions expressing red, using a red phosphor paste, a green phosphor paste is printed with a different exchanged, and a blue phosphor paste is finally printed with a different mask.

The printing process comprises a drying process at a temperature of 80° C. to 150° C. After all phosphors are printed through the above described procedure, they are fired through the firing process at a temperature of 350° C. to 550° C., thereby forming the phosphor layer.

Although the method for forming the phosphor layer between the barrier ribs by using the screen printing method allows for the use of less expensive equipment to carry out the process, a phenomenon where the phosphor paste blocks the mask can occur, thereby deteriorating the reliability of the printing process. Another drawback of the screen printing method is its inability to accurately control the thickness of the printed phosphor layer. And a failure of the phosphor layer occurs because of abrasion of a squeeze, of printing the paste through the mask, thereby increasing a manufacture cost.

The phosphor layer of the rear panel is formed through the screen printing method using the mask or the dispensing method using the dispensing device.

A method for forming the phosphor layer of the plasma display panel by using the screen printing method will be described below. First, a phosphor paste is prepared, and is printed between the barrier ribs at a plurality of times using the mask.

The phosphors expressing either red, green or blue are printed at each pixel region, and the printing is repeated several times to form the phosphor layer having a suitable thickness and uniformity. In other words, after the printing is concurrently performed for all pixel regions expressing red, using the red phosphor paste, a green phosphor paste is again printed with a different mask, and a blue phosphor paste is finally printed with a different mask.

The printing process comprises a drying process at a temperature of 80° C. to 150° C. After all phosphors are printed through the above described procedure, they are fired through the firing process at a temperature of 350° C to 550° C., thereby forming the phosphor layer.

Although, the method for forming the phosphor layer between the barrier ribs by using the screen printing method allows for the use of less expensive equipment to carry out the process, a phenomenon where the phosphor paste blocks the mask can occur, thereby deteriorating the reliability of the printing process. Another drawback of the screen printing method its inability to accurately control the thickness of the printed phosphor layer. And a failure of the phosphor layer occurs because of abrasion of a squeeze of printing the paste through the mask, thereby increasing a manufacture cost.

Given the above problem associated with the screen printing method, the dispensing method using the dispensing device is currently the preferred method to form the phosphor layer.

FIG. 5 illustrates a conventional procedure of forming the phosphor layer of the conventional plasma display panel using the dispensing device.

As shown in FIG. 5, the dispensing device-comprises a server 510, a pressurization pump 520, and a header 530. A phosphor slurry 550 is pressurized and supplied from the server 510 to the header 530 by the pressurization pump 520.

A slurry chamber 530a and a nozzle 540 are installed at the header 530, and the phosphor slurry 550 supplied to the slurry chamber 530a is continuously discharged from the nozzle 540.

The header 530 is linearly driven using a header injection apparatus (not shown), and the header injection apparatus allows the header 530 to inject and at the same time, continuously discharge the phosphor slurry 550 from the nozzle 540, thereby uniformly coating the phosphor slurry between the barrier ribs 112 on the rear panel 110. The phosphor slurry is then fired at a temperature of 350° C. to 550° C., thereby forming the phosphor layer.

As described above, in case where the phosphor layer is formed by using the dispensing device, the phosphor slurry is uniformly coated between the barrier ribs. But the viscosity of the phosphor slurry is lower than the viscosity of the phosphor paste that is used when the phosphor layer is formed in the screen printing method. The low viscosity of the phosphor slurry has a drawback of causing a mixture of the phosphor formed within the discharge cell. In other words, when the low viscosity phosphor slurry is dispensed between the barrier ribs, the phosphor slurry flows into an adjacent discharge cell and causes the mixture of the phosphor instead of forming only in the desired discharge cell. The mixture of the phosphor can also easily occur through the misalignment of the dispensing device and the barrier rib of the panel.

The mixture of the phosphor easily occurs in the situation where the phosphor slurry is dispensed, a structure of the discharge cell, that is, a structure of the barrier rib is a closed type having a row barrier rib and a column barrier rib. Colar mixing occurs because when the phosphor slurry is dispensed, it flows along the top of a row barrier rib of the closed typed barrier ribs to the top of an adjacent row barrier rib, thereby forming an undesired phosphor in adjacent discharge cells. The row barrier rib refers to a barrier rib for partitioning the discharge space where the same color phosphor, for example, a red only phosphor, a green only phosphor, or a blue only phosphor is coated, as one unit pixel, and the column barrier rib refers to a barrier rib for separating and partitioning the red, green and blue phosphors as the unit pixel, respectively, in the discharge space where the red phosphor, the green phosphor, or the blue phosphor is coated.

A phosphor slurry with a high viscosity can prevent color mixture, but has a drawback by causing the nozzle of the dispensing device to become clogged and interrupting the spray of phosphors, thereby preventing the phosphor slurry to be coated as desired.

A conventional method for forming the well type structured barrier rib having the height difference of FIG. 4 will be described below.

FIGS. 6A to 6E sequentially illustrate the conventional method of manufacturing the well type barrier rib having a different height in the plasma display panel.

As shown in FIG. 6A, a lower dielectric 115 is formed on the rear glass 111 having an electrode (not shown) mounted, and a barrier rib paste 112 having a predetermined thickness is formed on the lower dielectric 115 by using a printing method or a coating method. Then, a dry film resin (DFR) 120 is formed on the barrier rib paste 112 through a laminating process, an exposure process aligns a photomask 121 having a predetermined pattern on the DFR 120, and irradiation with a light such as vacuum ultraviolet rays occurs.

After the exposure process of the DFR 120, a developing process is performed as shown in FIG. 6B. In the developing process, the DFR 120 not exposed to the light (Hereinafter, referred to as “nonexposure region”) remains on the barrier rib paste 112, whereas the DFR 120 exposed to the light (Hereinafter, referred to as “exposure region”) is etched out.

Next, as shown in FIG. 6C, a sand blasting device 130 is positioned and driven over the barrier rib paste 112 and the DFR 120 that are subjected to the developing process, and sprays sand particles on the barrier rib paste 112. The barrier rib paste 112 is then cut out due to sputtering of the sand particles whereas the paste 112 corresponding to the barrier rib is protected by a DFR 120 pattern.

As shown in FIG. 6D, a peeling process is then performed for the barrier rib protected and formed by the DFR 120, to form the first and second barrier ribs 112a and 112b.

As shown in FIGS. 6A to 6D, the first and second barrier ribs 112a and 112b having predetermined patterns can be formed by forming and exposing the DFR on a top of the barrier rib paste. The first and second barrier ribs 112a and 112b can be also formed by containing and exposing a photosensitive material in the barrier rib paste itself. The first and second barrier ribs 112a and 112b can be also formed by forming and exposing the photosensitive material on the dielectric with a green sheet.

As shown in FIG. 6E, the barrier rib paste having a predetermined height is formed on the second barrier rib 112b by using the direct patterning method, to form the first and second barrier ribs 112a and 112b having the heights different from each other.

As such, in manufacturing the well type structured barrier rib where the first and second barrier ribs 112a and 112b have different heights, there is a drawback in that the manufacturing process is complicated because the first and second barrier ribs are formed to have the same height and then the paste is again coated and exposed on the second barrier rib to generate the height difference between the first and second barrier ribs 112a and 112b. Further, there is a drawback in that the uniformity of the barrier rib film is reduced since the exposure process is performed several times.

The black color layer 116 of FIG. 1 is formed on the barrier rib 112 in the screen printing method. That is, a black color layer paste is printed on the barrier rib 112 having a screen mask disposed, by using a squeeze to which a predetermined pressure is applied. The printed black color layer paste is dried, and the printing and drying processes are repeated several times.

As shown in FIG. 7, the black color layer formed by using the screen printing method has a drawback in that when the black color layer is formed on the barrier rib 112, it is difficult to maintain to create a uniform coat when the desired thickness of the black color layer is several μm.

In the case where the black color layer 116 is not uniformly coated at a predetermined thickness, a luminance deviation of the plasma display panel occurs. Further, the problem of a deviation of the driving characteristic depending on variation of a permittivity of the plasma display panel will also occur.

### SUMMARY OF THE INVENTION

Accordingly, an object of the present invention is to solve at least the problems and disadvantages of the background art.

An object of the present invention is to provide a plasma display apparatus, a plasma display panel, and a manufacturing method of the plasma display panel, for improving a barrier rib structure, thereby more improving an exhaust characteristic.

Another object of the present invention is to provide a plasma display apparatus, a plasma display panel, and a manufacturing method of the plasma display panel, for improving a barrier rib structure, thereby preventing color mixture irrespective of an alignment characteristic between a dispensing device and a barrier rib and a viscosity characteristic of a phosphor slurry.

A further another object of the present invention is to provide a plasma display apparatus, a plasma display panel, and a manufacturing method of the plasma display panel, for improving a barrier rib structure, thereby reducing noise.

Yet another object of the present invention is to provide a manufacturing method of a plasma display panel, for improving THE manufacturING process of a barrier rib, thereby reducing the number of the manufacturing process and improving the uniformity of the barrier rib film.

Still another object of the present invention is to provide a manufacturing method of a plasma display panel, for improving the manufacture process of a barrier rib, thereby reducing the manufacturing process in number and improving the uniformity of the thickness of the black color film.

To achieve these and other advantages and in accordance with the purpose of the present invention, as embodied and broadly described, there is provided a plasma display panel comprises a row barrier rib partitioning adjacent cells having the same phosphor coating, and having a groove at its top and a column barrier rib intersecting with the row barrier rib.

In another aspect of the present invention, there is provided a plasma display apparatus comprises a row barrier rib partitioning adjacent cells having the same phosphor coating, and having a groove at its top and a column barrier rib intersecting with the row barrier rib.

In another aspect of the present invention, there is provided a method of manufacturing a plasma display panel having a discharge cell partitioned by a row barrier rib and a column barrier rib, and a phosphor coating in the discharge cell, the method comprises the steps of forming the row barrier rib and the column barrier rib along a pattern of the row barrier rib and a pattern of the column barrier rib; and etching a portion of a top of the row barrier rib, and providing a groove at the top of the row barrier rib.

In a yet another aspect of the present invention, there is provided a plasma display panel, a row barrier rib and a column barrier rib having heights different from each other partition a discharge cell, and the row barrier rib or the column barrier rib having the lower height has a groove at its top.

In a still another aspect of the present invention, there is provided a plasma display apparatus, a row barrier rib and a column barrier rib having heights different from each other partition a discharge cell, and the row barrier rib or the column barrier rib having the lower height has a groove at its top.

In a still another aspect of the present invention, there is provided method of manufacturing a plasma display panel having a phosphor coated in a discharge cell, comprises the steps of coating a barrier rib paste on a dielectric formed on a glass; placing a photomask having a predetermined pattern on the barrier rib paste, and forming a row barrier rib pattern and a column barrier rib pattern partitioning the discharge cell, and etching the row barrier rib pattern and the column barrier rib pattern, forming a row barrier rib and a column barrier rib having heights different from each other, and providing a groove at a top of the row barrier rib or the column barrier rib having the lower height.

In a still another aspect of the present invention, there is provided a plasma display panel, wherein row barrier ribs and column barrier ribs are formed to have heights different from each other in a discharge region of the panel, and wherein some of the row barrier ribs have the same heights as the heights of the column barrier ribs in a nondischarge region of the panel.

In a still another aspect of the present invention, there is provided a plasma display apparatus, wherein a row barrier rib and a column barrier rib are formed to have heights different from each other in a discharge region of a plasma display panel, and wherein some of the row barrier ribs have the same height as the column barrier ribs in a nondischarge region of the panel.

In a still another aspect of the present invention, there is provided a method of manufacturing a plasma display panel having phosphors coated in discharge cells of a discharge region and a nondischarge region, the method comprising the steps of coating a barrier rib paste on a dielectric formed on a glass of the discharge region and the nondischarge region, forming a row barrier rib and a column barrier rib having first heights on the barrier rib paste along a predetermined pattern, and etching each top of some of the row barrier ribs formed in the discharge region, and forming the row barrier rib having second heights lower than the first heights.

In a still another aspect of the present invention, there is provided a method of manufacturing a plasma display panel, the method comprising the steps of forming a coating film on a dielectric formed on a glass, placing a photomask having a row direction pattern and a column direction pattern having widths different from each other, on the coating film, and forming a row barrier rib pattern and a column barrier rib pattern and etching the row barrier rib pattern and the column barrier rib pattern, and forming a row barrier rib and a column barrier rib having heights different from each other.

In a still another aspect of the present invention, there is provided a barrier rib green sheet of a plasma display panel, comprises a base film, a barrier rib dry film having a black color layer and a barrier rib layer formed on the base film and a cover film formed on the barrier rib dry film.

The present invention improves an exhaust characteristic by using the height difference between the row barrier ribs and the column barrier ribs and the groove provided at the top of the barrier rib.

The present invention can prevent the phosphor from flowing into an adjacent discharge cell, and can prevent the color mixture of the phosphors by using the height difference between the row barrier rib and the column barrier rib and the groove provided at the top of the barrier rib.

The present invention can reduce a noise caused the plasma by using the height difference between the row barrier rib and the column barrier rib in the discharge region and in the nondischarge region.

The present invention can differentiate the widths of the row pattern and the column pattern of the mask, thereby reducing the process of forming the barrier rib and can improve the uniformity of the barrier rib film by using a green sheet.

The present invention can reduce the process of forming the black color layer and improve the uniformity of the black color layer by using the green sheet.

### BRIEF DESCRIPTION OF THE DRAWINGS

The invention will be described in detail with reference to the following drawings in which like numerals refer to like elements.

FIG. 1 illustrates a structure of a conventional plasma display panel;

FIGS. 2 to 4 illustrate conventional barrier rib structures of plasma display panels;

FIG. 5 illustrates a conventional procedure of forming a phosphor layer of a plasma display panel using a dispensing device;

FIGS. 6A to 6E sequentially illustrate a conventional method of manufacturing a well type barrier rib having a different height in a plasma display panel;

FIG. 7 illustrates a black color layer formed by using a conventional screen printing method;

FIG. 8 is a perspective view illustrating a barrier rib structure of a plasma display panel according to the first embodiment of the present invention;

FIGS. 9A to 9E sequentially illustrate a procedure of forming a barrier rib of a plasma display panel according to the first embodiment of the present invention;

FIG. 10 is a perspective view illustrating a barrier rib structure of a plasma display panel according to the second embodiment of the present invention;

FIGS. 11A to 11D sequentially illustrate a procedure of forming a barrier rib of a plasma display panel according to the second embodiment of the present invention;

FIG. 12 is a perspective view illustrating a barrier rib structure of a plasma display panel according to the third embodiment of the present invention;

FIGS. 13A to 13F sequentially illustrate a procedure of forming a barrier rib of a plasma display panel according to the third embodiment of the present invention;

FIG. 14 sequentially illustrates a manufacturing method of a plasma display panel according to the present invention;

FIGS. 15A to 15C sequentially illustrate a manufacturing method of a barrier rib of a plasma display panel according to the present invention;

FIG. 16 illustrates a green sheet of a plasma display panel according to an embodiment of the present invention;

FIGS. 17A to 17C illustrate a manufacturing method of a barrier rib green sheet according to an embodiment of the present invention;

FIG. 18 illustrates a green sheet of a plasma display panel according to another embodiment of the present invention;

FIG. 19 illustrates a green sheet of a plasma display panel according to a further another embodiment of the present invention;

FIGS. 20A to 20C illustrate a method of forming a dielectric green sheet according to another embodiment of the present invention; and

FIGS. 21A to 21E illustrate a procedure of manufacturing a rear substrate of a plasma display panel by using a green sheet according to another embodiment of the present invention.

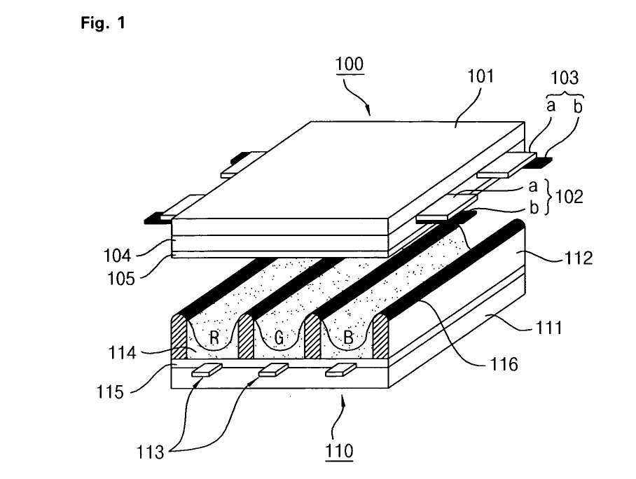

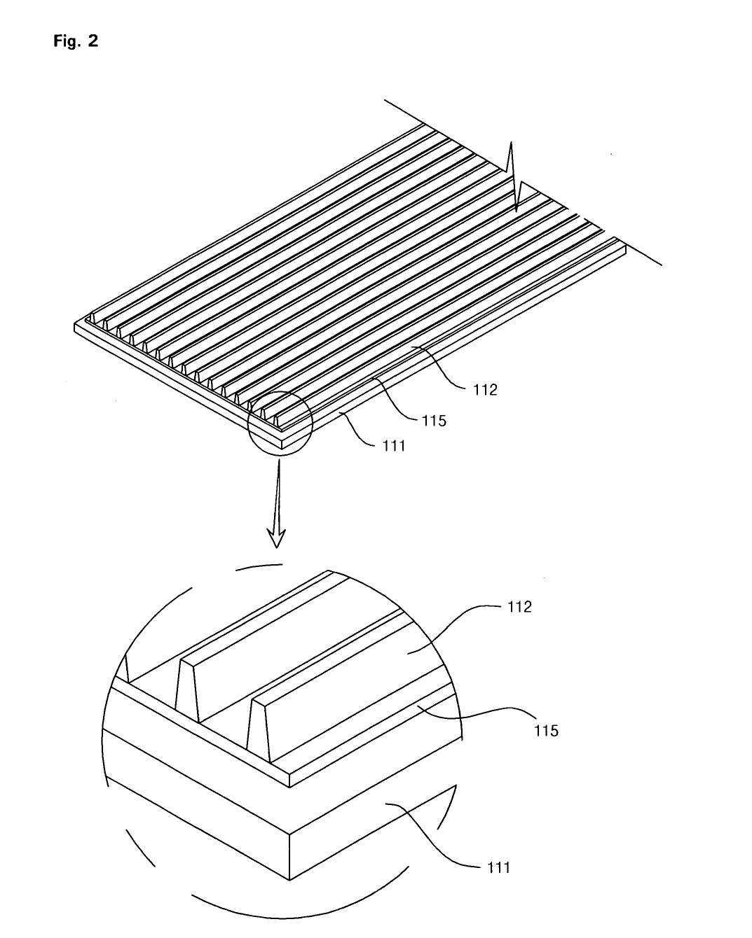

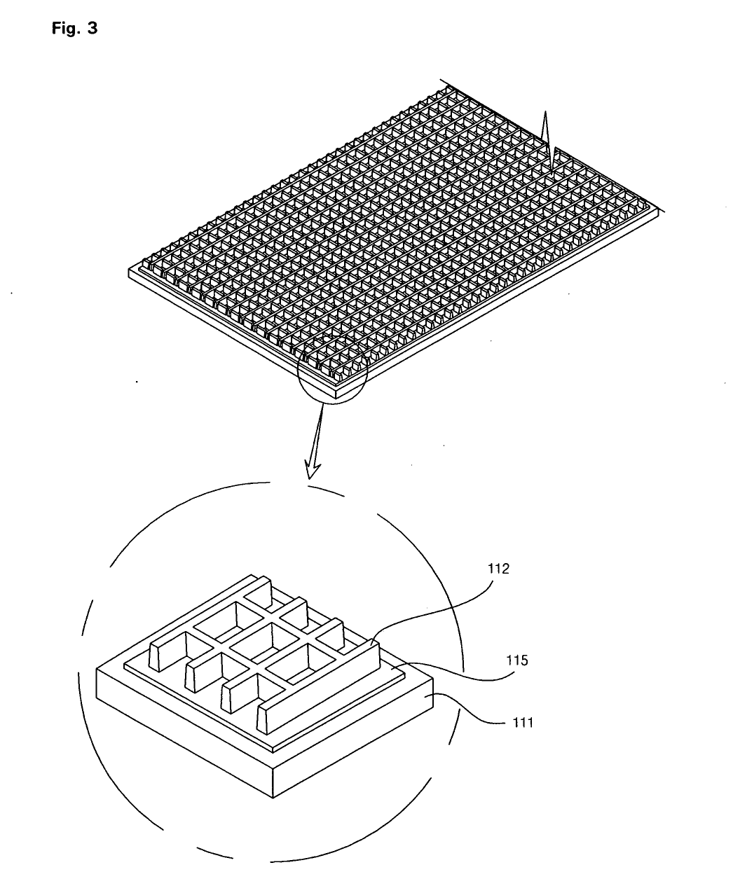

### DETAILED DESCRIPTION OF PREFERRED EMBODIMENTS

Preferred embodiments of the present invention will be described in a more detailed manner with reference to the drawings.

A plasma display panel comprises a row barrier rib partitioning adjacent cells having the same phosphor coating, and having a groove at its top and a column barrier rib intersecting with the row barrier rib.

The row barrier rib may have at least one groove at a top thereof.

The groove may have a width of 5% to 90% of a top width of the row barrier rib.

The groove may have a width of 10 μm to 200 μm.

A plasma display apparatus comprises a row barrier rib partitioning adjacent cells having the same phosphor coating, and having a groove at its top and a column barrier rib intersecting with the row barrier rib.

A method of manufacturing a plasma display panel having a discharge cell partitioned by a row barrier rib and a column barrier rib, and a phosphor coating in the discharge cell, the method comprises the steps of forming the row barrier rib and the column barrier rib along a pattern of the row barrier rib and a pattern of the column barrier rib and etching a portion of a top of the row barrier rib, and providing a groove at the top of the row barrier rib.

The etching may be performed by using either an etching method or a sand blasting method.

The phosphor may be formed by using a direct patterning method.

The direct patterning method may be either an inkjet method or a dispensing method.

The row barrier rib and the column barrier rib may have the same height.

In a plasma display panel, a row barrier rib and a column barrier rib having heights different from each other partition a discharge cell, and the row barrier rib or the column barrier rib having a lower height has a groove at its top.

The groove may be positioned at the top and center of the row barrier rib or the column barrier rib having the lower height.

The row barrier rib may have the lower height.

The groove may have a width of 5% to 90% of the top width of the row barrier rib.

The groove may have a width of 10 μm to 200 μm.

In a plasma display apparatus, a row barrier rib and a column barrier rib having heights different from each other partition a discharge cell, and the row barrier rib or the column barrier rib has a lower height has a groove at its top.

A method of manufacturing a plasma display panel having a phosphor coated in a discharge cell, comprises the steps of coating a barrier rib paste on a dielectric formed on a glass, placing a photomask having a predetermined pattern on the barrier rib paste, and forming a row barrier rib pattern and a column barrier rib pattern partitioning the discharge cell, etching the barrier rib paste along the row barrier rib pattern and the column barrier rib pattern and forming a row barrier rib and a column barrier rib having heights different from each other, and providing a groove at a top of the row barrier rib or the column barrier rib having the lower height.

The height of the row barrier rib may be less than the height of the column barrier rib.

The width of the pattern of the photomask for the forming the row barrier rib may be narrower than the width of the pattern of the photomask for forming column barrier rib, and the width of a portion of the pattern of the row barrier rib may be narrower than the remaining portion of the pattern of the row barrier rib.

The width of the pattern of a central portion of the row barrier rib may be smaller than the width of the pattern of the remaining portion of the row barrier rib.

The phosphor may be formed by using a direct patterning method.

The direct patterning method is either an inkjet method or a dispensing method.

The etching is isotropic etching.

In a plasma display panel, row barrier ribs and column barrier ribs are formed to have heights different from each other in a discharge region of the panel, and some of the row barrier ribs have the same heights as the heights of the column barrier ribs in a nondischarge region of the panel.

The row barrier rib has a lower height than the column barrier rib in the discharge region of the panel.

The row barrier rib has a height of 70% to 80% of a height of the column barrier rib.

At least one of the row barrier ribs has a lower height than the remaining row barrier ribs.

A groove is provided at a top of at least one of the row barriers formed in the discharge region of the panel.

A groove is provided at a top of at least one of the column barriers formed in the discharge region of the panel.

A groove is provided at a top of at least one of the column barriers formed in the nondischarge region of the panel.

Heights of one or more of the row barrier ribs formed in the nondischarge region of the panel is lower than the heights of the column barrier ribs, and a groove is provided at each top of the one or more row barrier ribs.

In a plasma display apparatus, a row barrier rib and a column barrier rib are formed to have heights different from each other in a discharge region of a plasma display panel. Some of the row barrier ribs have the same height as the column barrier ribs in a nondischarge region of the panel.

A method of manufacturing a plasma display panel having phosphors coated in discharge cells of a discharge region and a nondischarge region, comprises the steps of coating a barrier rib paste on a dielectric formed on a glass of the discharge region and the nondischarge region; forming row barrier ribs and column barrier ribs having first heights through etching the barrier rib paste along a predetermined pattern; and etching each top of one or more of the row barrier ribs formed in the discharge region for forming the row barrier rib having a second height lower than the first height.

Each top of at least one of the one or more row barrier ribs having the second heights may be etched.

At least one of the row barrier ribs and the column barrier ribs in the discharge region is partially etched to have a groove at its top.

The row barrier rib having the lower height than the second height is partially etched to have a groove at its top.

The method further comprises the step of etching each top of at least one of the row barrier ribs of the nondischarge region.

The row barrier rib is partially etched to have a groove at its top.

The phosphor is formed by using a direct patterning method.

The direct patterning method is either an inkjet method or a dispensing method.

A method of manufacturing a plasma display panel, comprises the steps of forming a coating film on a dielectric formed on a glass, placing a photomask having a row direction pattern and a column direction pattern having widths different from each other, on the coating film, and forming a row barrier rib pattern and a column barrier rib pattern, and etching the barrier rib paste along the pattern of the photomask for forming a row barrier rib and a column barrier rib having heights different from each other.

The column direction pattern has a greater width than the row direction pattern.

The column direction pattern is two times to three times of the width of the row direction pattern.

The height of the column barrier rib is more than the height of the row barrier rib.

The coating film is formed of either a barrier rib paste or a green sheet.

A dry film of the green sheet is formed to have a plurality of layers.

The dry film is formed to have the plurality of layers having dielectric constants different from one another.

The dry film layer forming a barrier rib near to a display surface of the panel, among the plurality of dry film layers, has a dark color.

A barrier rib green sheet of a plasma display panel, comprises a base film, a barrier rib dry film having a black color layer and a barrier rib layer formed on the base film, and a cover film formed on the barrier rib dry film.

The black color layer has a thickness of 0.1 μm to 10 μm.

The barrier rib layer is formed to have a plurality of layers having materials different from one another.

The plurality of layers is different from one another in permittivity.

The black color layer is either an uppermost layer or a lowermost layer of the barrier rib dry film.

### First Embodiment

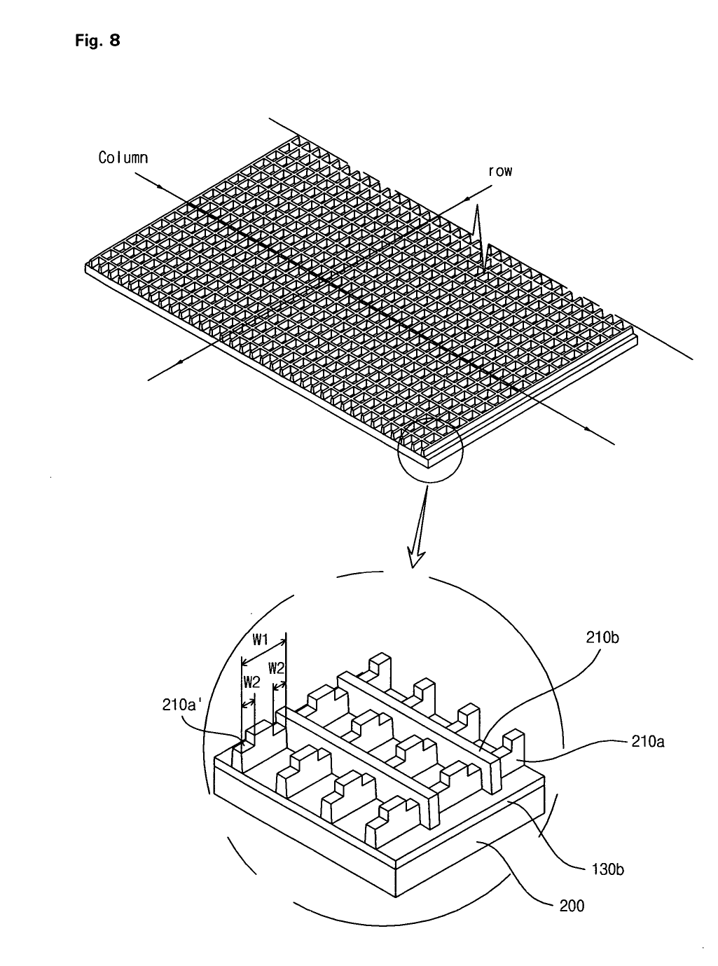

FIG. 8 is a perspective view illustrating a barrier rib structure of a plasma display panel according to the first embodiment of the present invention. Before a description of FIG. 8, though not illustrated in the drawings, the inventive plasma display panel comprises a front panel being a display surface for displaying an image, and a rear panel being a rear surface and sealed to the front panel at a distance as in a conventional art.

The front panel comprises a sustain electrode pair arranged with a scan electrode and a sustain electrode each paired and formed on a front glass, and an upper dielectric layer is layered on the front glass having the scan electrode and the sustain electrode arranged in parallel, and limits a discharge electric current. A protective layer having oxide magnesium (MgO) deposited is formed on the upper dielectric layer, and prevents the upper dielectric layer from being damaged due to sputtering generated in plasma discharge and increases the emission efficiency of secondary electrons.

The rear panel comprises an address electrode arranged on a rear glass to intersect with the sustain electrode pair arranged in parallel on the front glass, and a lower dielectric layer is formed on the address electrode and accumulates wall charges. A barrier rib is formed on the lower dielectric layer, and partitions a discharge cell. A phosphor layer is coated in a discharge cell space, and generates visible rays having either R (red), G (green), or B (blue) colors in discharge.

As shown in FIG. 8, the barrier rib formed at the plasma display panel according to the first embodiment of the present invention is a closed type where the discharge cell is partitioned by a row barrier rib 210a and a column barrier rib 210b. The row barrier rib 210a has a groove 210a′ at its top. Preferably, at least one groove 210a′ is formed on a top of the row barrier rib 210a. Preferably, the groove 210a′ is formed at one portion of the top of the row barrier rib 210a being in contact with the column barrier rib 210b. As shown in FIG. 8, the groove 210a′ does not necessarily have an angled shape, and can have even a smoothly curved shape. Together with the column barrier rib 210b, the groove 210a′ prevents a specific phosphor slurry from flowing into an adjacent discharge cell.

Preferably, the groove 210a′ is formed to have a width (W2) of 5 to 90% of a top width (W1) of the row barrier rib. Such a desired width is needed for the row barrier rib to possess the required mechanical strength of the barrier rib and spreading characteristic of the phosphor slurry coated in the discharge cell. In other words, the groove 210a′ has a width (W2) of more than 90% of the top width (W1) of the row barrier rib, there is a danger of reducing the mechanical strength of the barrier rib, thereby causing collapse, and when the groove 210a′ has a width (W2) of less than 5% of the top width (W1) of the row barrier rib, the phosphor is not only coated in a desired discharge cell but also flows into the adjacent discharge cell, thereby being incapable of sufficiently preventing the color mixture of the phosphor. Preferably, the groove provided at the top of the row barrier rib 210a has a width (W2) of 10 μm to 200 μm. A numerical value of the width (W2) of the groove is to also consideration of the mechanical strength of the barrier rib, and the spreading of the phosphor slurry coated in the discharge cell.

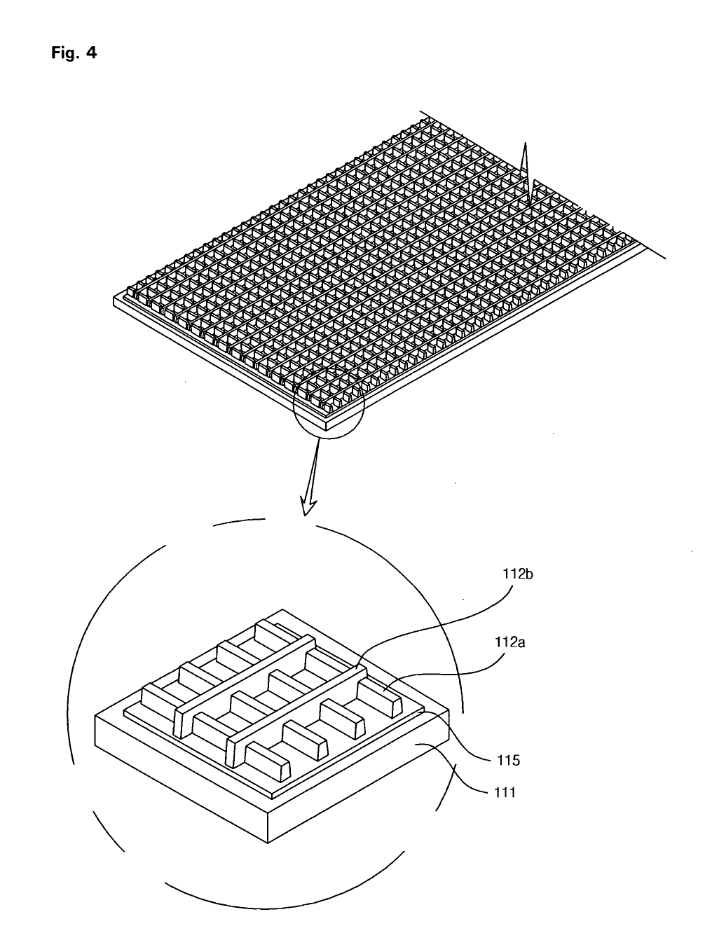

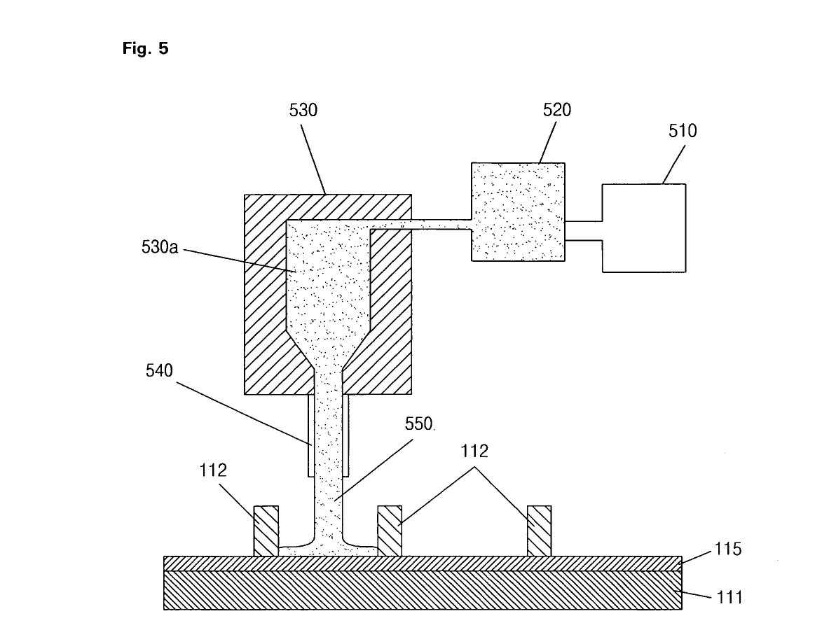

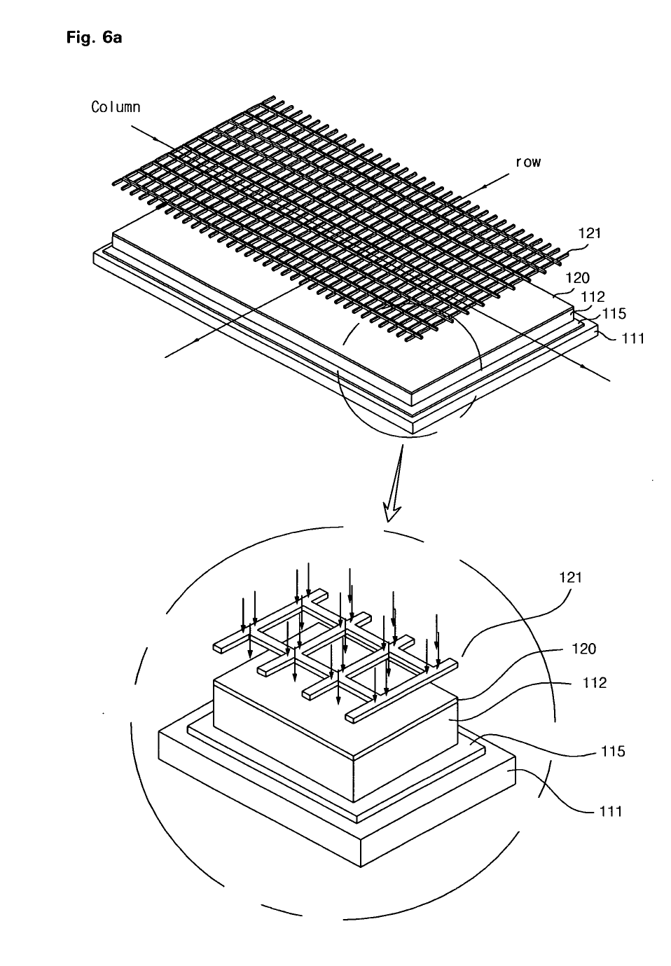

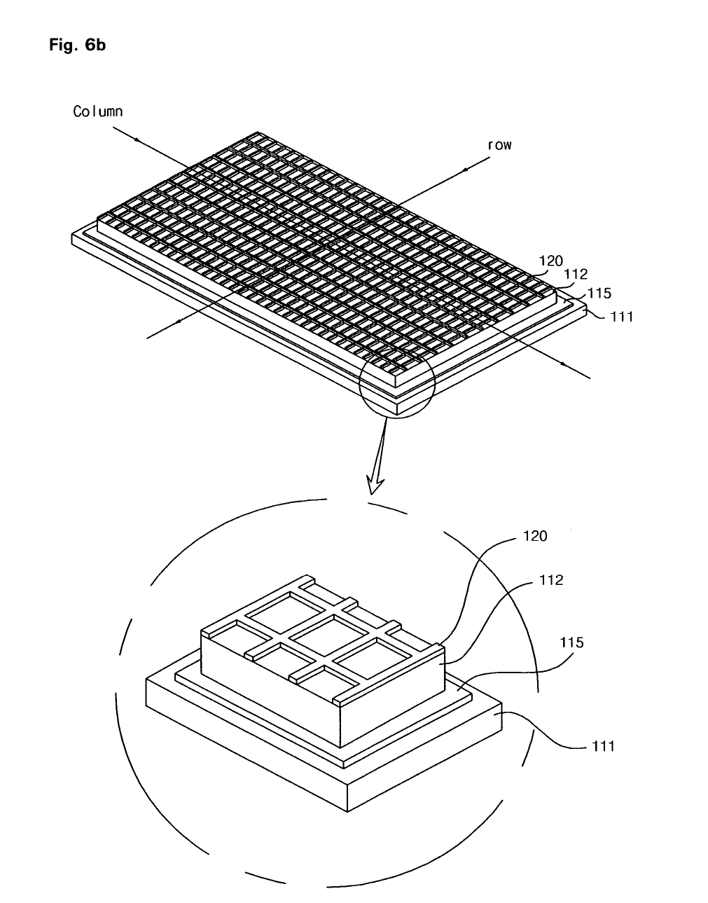

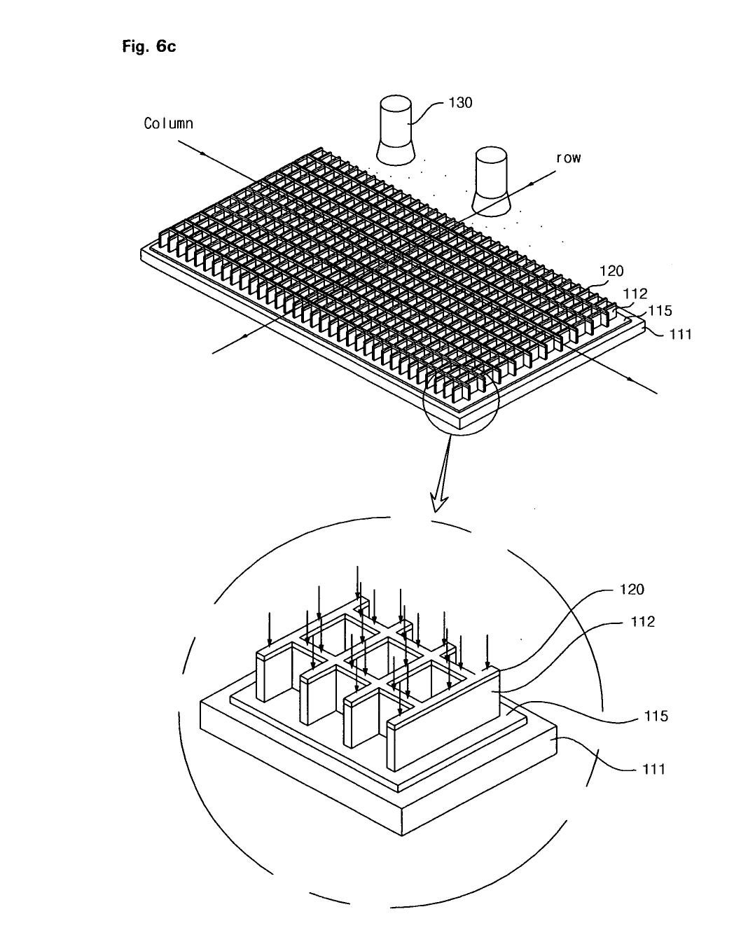

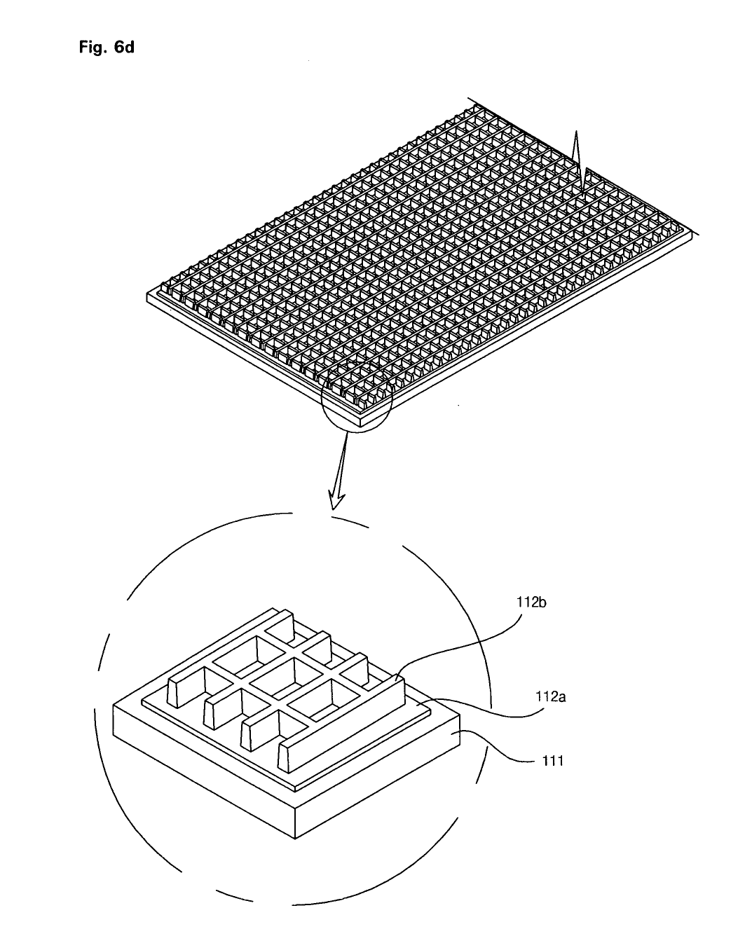

The plasma display panel having the above barrier rib according to the first embodiment of the present invention more improves the exhaust characteristic of the impure gas better than a plasma display panel having a conventional barrier rib structure of FIG. 4. In other words, if the groove 210a′ is provided at the top of the barrier rib as in the first embodiment of the present invention, the groove 210a′ forms a predetermined space serving as an exhaust path of the impure gas, thereby improving the exhaust characteristic better than a conventional barrier rib structure.

A plasma display apparatus according to the present invention comprises a driver (not shown) for driving the plasma display panel, and the barrier rib structure of the plasma display panel is as described above.

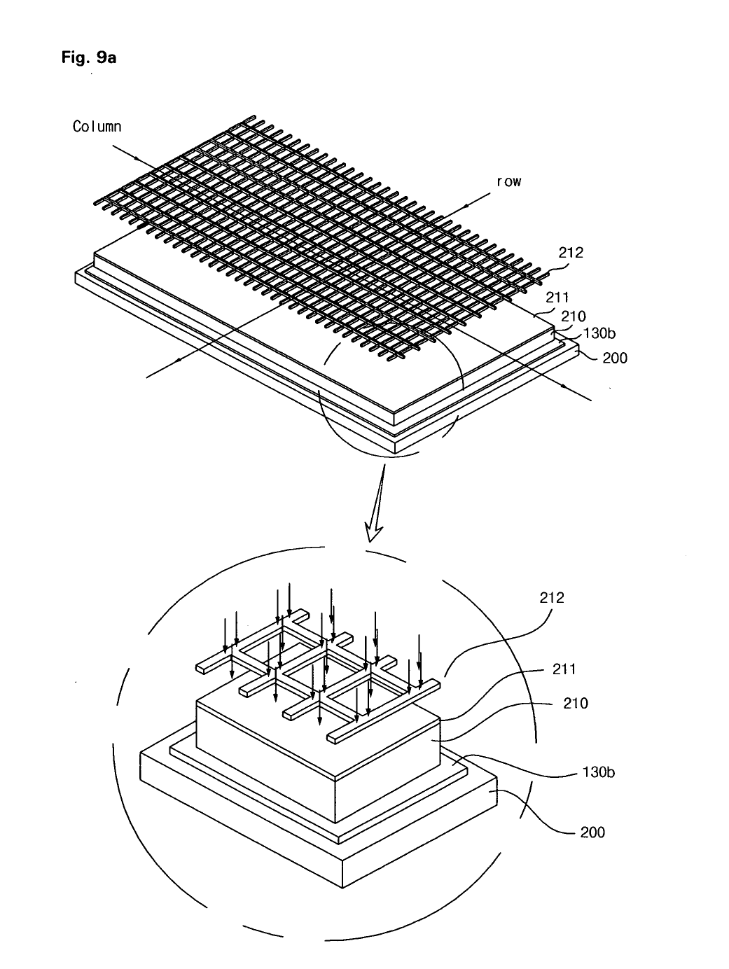

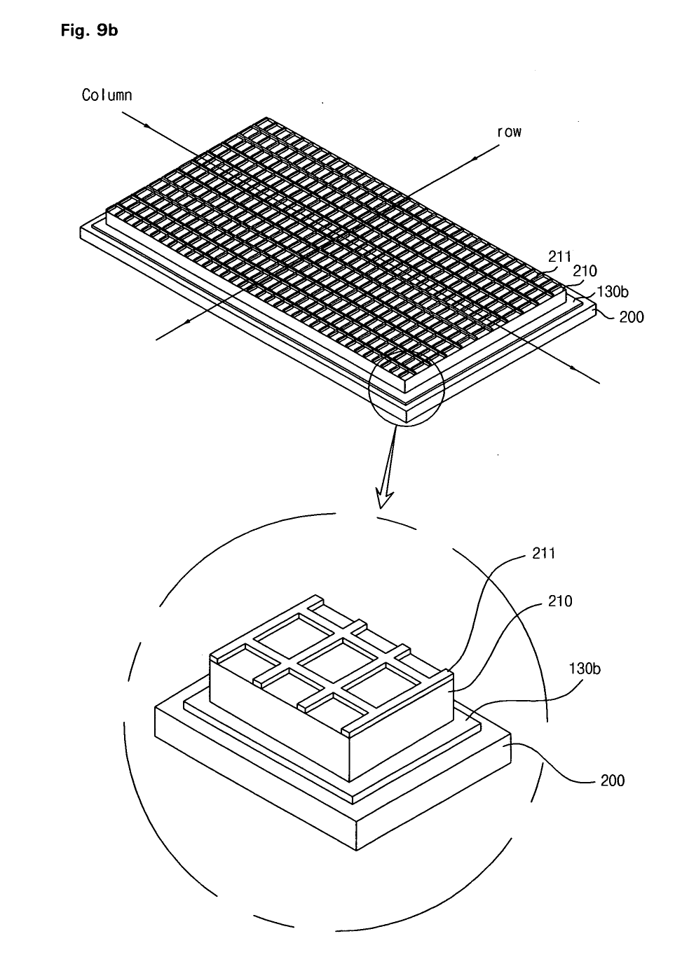

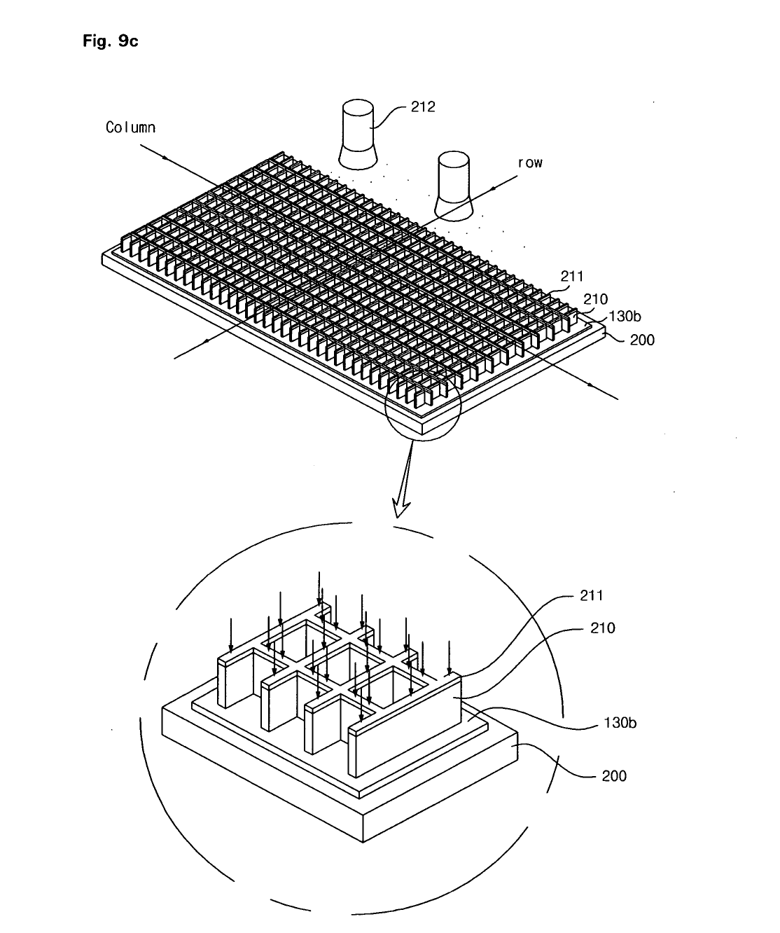

FIGS. 9A to 9E sequentially illustrate a procedure of forming the barrier rib of the plasma display panel according to the first embodiment of the present invention.

As shown in FIG. 9A, a lower dielectric 130b is formed on a rear glass 200 having an electrode (not shown) mounted, and a barrier rib paste 210 is formed to have a predetermined thickness on the lower dielectric 130b by using a printing method or a coating method. A dry film resin (DFR) 211 is formed on the barrier rib paste through a laminating process, and an exposure process of aligns a photomask 212 having a predetermined pattern on the DFR and irradiation with a light such as ultraviolet rays occurs.

After the exposure process of the DFR 211, a developing process is performed as shown in FIG. 9B. In the developing process, the DFR 211 not exposed to the light (Hereinafter, referred to as “nonexposure region”) remains on the barrier rib paste 210, whereas the DFR 211 exposed to the light (Hereinafter, referred to as “exposure region”) is etched out.

Next, as shown in FIG. 9C, a sand blasting device 213 is positioned and driven over the barrier rib paste 210 and the DFR 211 that are subjected to the developing process, and sprays sand particles on the barrier rib paste 210. The barrier rib paste 210 is then cut out due to sputtering of the sand particles whereas the paste 210 corresponding to the barrier rib is protected by a DFR 211 pattern.

As shown in FIG. 9D, a peeling process is performed for the barrier rib 210 protected and formed by the DFR 211, to form the row barrier rib 210a and the column barrier rib 210b of the same height. The reason why the row barrier rib 210a and the column barrier rib 210b are formed to have the same height is to maintain a support strength of the barrier rib for the front panel.

As shown in FIGS. 9A to 9D, the row barrier rib and the column barrier rib having predetermined patterns can be formed by forming and exposing the DFR on the top of the barrier rib paste. The row barrier rib and the column barrier rib can be also formed by containing and exposing a photosensitive material in the barrier rib paste itself. In other words, a process of forming the patterns at the row barrier rib and the column barrier rib can employ not only the exposure process but also any of processes as long as the pattern can be formed.

As shown in FIG. 9E, the row barrier rib 210a is etched at its top to have a predetermined width by using either an etching method or a sand blast method, thereby forming the groove 210a′.

The row barrier rib 210a and the column barrier rib 210b manufactured in the above method partition the discharge cell of the plasma display panel.

The phosphor slurry is coated and the phosphor layer is formed in the partitioned discharge cell. A phosphor coating method can also employ a conventional screen printing method but preferably, employs a direct patterning method. The direct patterning method refers to a method for directly coating the phosphor slurry in the discharge cell through a nozzle of an inkjet device or a nozzle of a dispensing device, and forming the phosphor layer, without forming a phosphor pattern by using an auxiliary means such as a pattern mask as in the screen printing method. The screen printing method can be also used.

### Second Embodiment

FIG. 10 is a perspective view illustrating a barrier rib structure of a plasma display panel according to the second embodiment of the present invention. Before a description of FIG. 10, though not illustrated in the drawings, the inventive plasma display panel comprises a front panel being a display surface for displaying an image, and a rear panel being a rear surface and sealed to the front panel at a predetermined distance as in a conventional art.

The front panel comprises a sustain electrode pair arranged with a scan electrode and a sustain electrode each paired and formed on a front glass, and an upper dielectric layer is layered on the front glass having the scan electrode and the sustain electrode arranged in parallel, and limits the discharge electric current. A protective layer having oxide magnesium (MgO) deposited is formed on the upper dielectric layer, and prevents the upper dielectric layer from being damaged due to sputtering generated in plasma discharge and increases the emission efficiency of secondary electrons.

The rear panel comprises an address electrode arranged on a rear glass to intersect with the sustain electrode pair arranged in parallel on the front glass, and a lower dielectric layer is formed on the address electrode and accumulates wall charges. A barrier rib is formed on the lower dielectric layer, and partitions a discharge cell, and a phosphor layer is coated at a discharge cell space, and generates visible rays having either R (red), G (green), or B (blue) colors in discharge.

As shown in FIG. 10, the barrier rib formed at the above-constructed plasma display panel according to the present invention is a well type where the discharge cell is partitioned by surrounding a space by a row barrier rib 610a and a column barrier rib 610b on a lower dielectric 630b of the rear glass, and the row barrier rib 610a and the column barrier rib 610b have heights different from each other. The row barrier rib 610a refers to a barrier rib for partitioning the discharge space where the same color phosphor, for example, a red only phosphor, a green only phosphor, or a blue only phosphor is coated, as one unit pixel, and the column barrier rib 610b refers to a barrier rib for separating and partitioning the red, green and blue phosphors as the unit pixel, respectively, in the discharge space where the red phosphor, the green phosphor, or the blue phosphor is coated.

The height of the row barrier rib 610a is lower than the height of the column barrier rib 610b. The column barrier rib 610b for separating the red, green and blue phosphors, respectively, in the discharge space where the red phosphor, the green phosphor, or the blue phosphor are coated, is formed to have a greater height than the row barrier rib 610a so as to prevent the color mixture of the phosphors. The color mixture of the phosphors occurs when the phosphor is coated in the discharge cell partitioned as the row barrier rib 610a and the column barrier rib 610b, the phosphor flows into an adjacent discharge cell due to a viscosity characteristic of the phosphor. In other words, the row barrier rib 610a is formed to have the lower height than the column barrier rib 610b, thereby improving the exhaust characteristic and also the discharge characteristic.

The row barrier rib 610a having the lower height than the column barrier rib 610b has a groove 610a′ at its top and central portion. Preferably, at least one groove 610a′ is provided on the top of the row barrier rib 610a. The groove 610a′ can be provided at any portion of the top of the row barrier rib 610a. The groove 610a′ does not necessarily have an angled shape and can have even a smoothly curved shape. In the groove 610a′, a height of the lowest portion can also correspond to a bottom. Together with the column barrier rib 610b, the groove 610a′ prevents a specific phosphor slurry from flowing into an adjacent discharge cell.

The groove 610a′ has a width (W2) of 5% to 90% of the top width (W1) of the row barrier rib. When the groove 610a′ has a width (W2) less than 5% of the top width (W1) of the row barrier rib, the phosphor is not only coated in a desired discharge cell but also flows into the adjacent discharge cell, thereby being incapable of sufficiently preventing a color mixture of the phosphor. When the groove 610a′ has a width (W2) of more than 90% of the top width (W1) of the row barrier rib, there is a danger of reducing the mechanical strength of the barrier rib, thereby causing collapse. Preferably, the groove provided at the top of the row barrier rib 610a has a width (W2) of 10 μm to 200 μm. A numerical value of the width (W2) of the groove is also consideration of the mechanical strength of the barrier rib, and the spreading of the phosphor slurry coated in the discharge cell.

The plasma display panel having the above barrier rib according to the second embodiment of the present invention improves the exhaust characteristic of the impure gas better than a plasma display panel having a conventional barrier rib structure of FIG. 4. In other words, if the groove 610a′ is provided at the top of the barrier rib as in the second embodiment of the present invention, the groove 610a′ forms a predetermined space serving as an exhaust path of the impure gas, thereby improving the exhaust characteristic better than conventional methods.

A plasma display apparatus according to the present invention comprises a driver (not shown) for driving the plasma display panel, and the barrier rib structure of the plasma display panel is as described above.

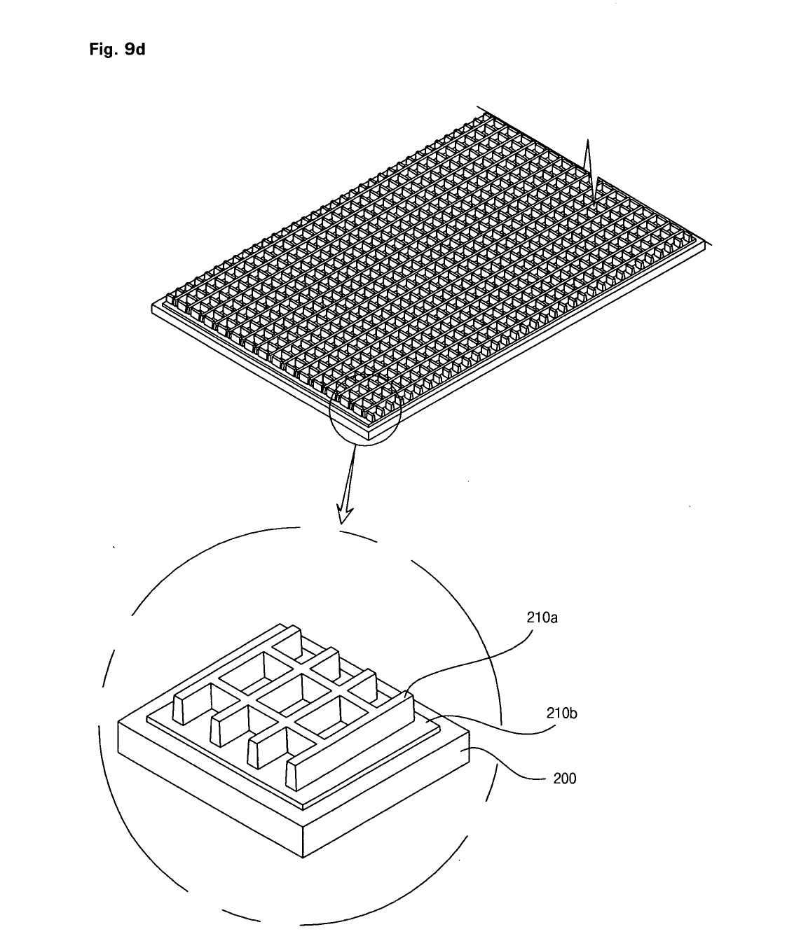

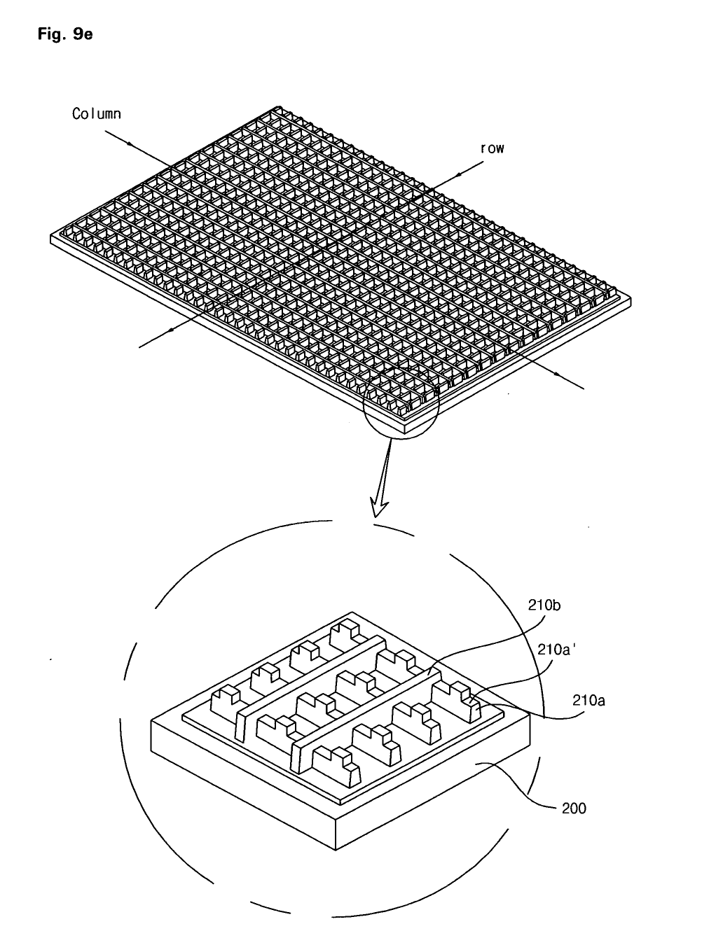

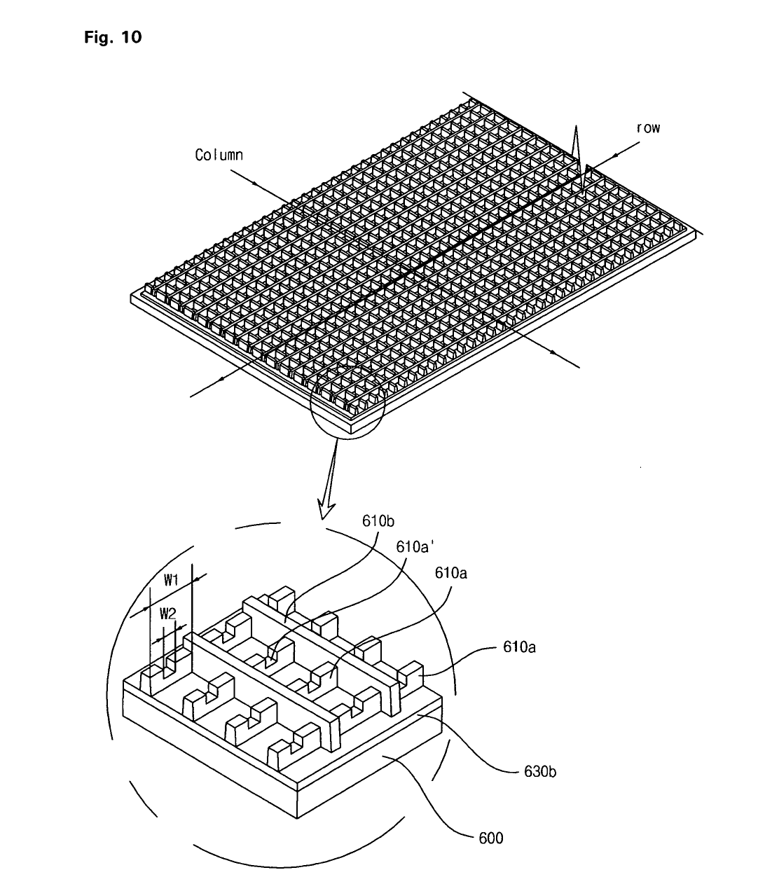

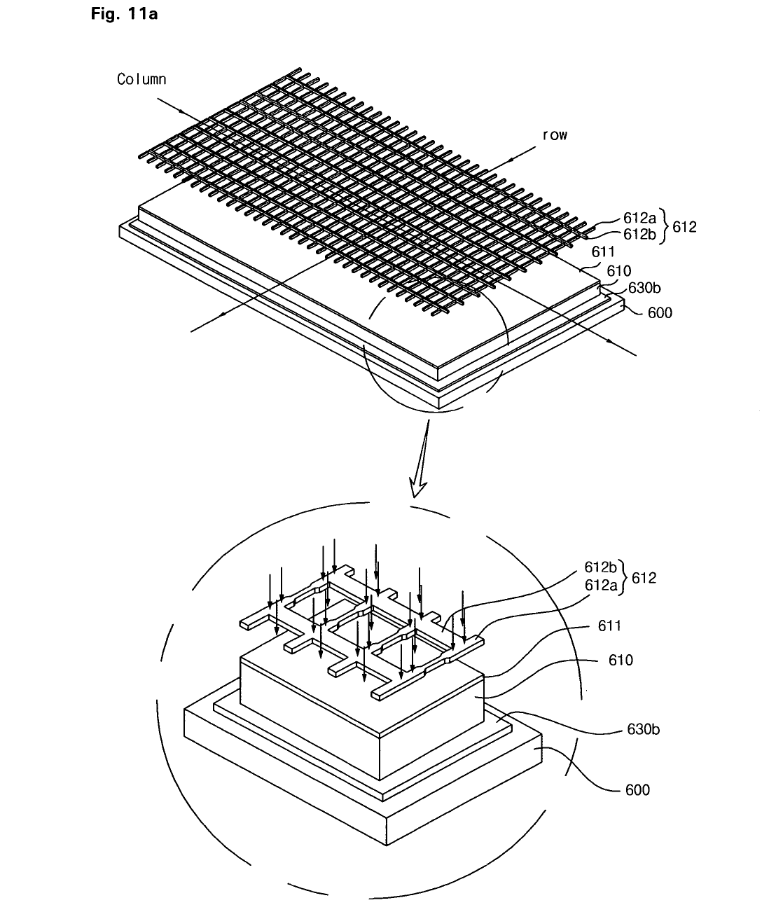

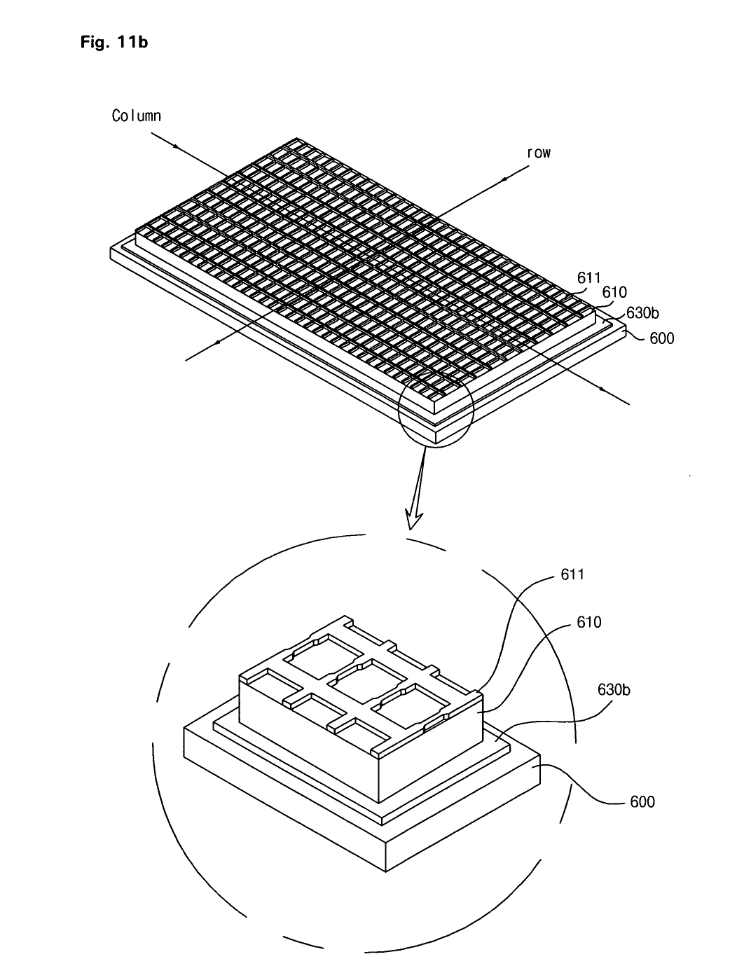

FIGS. 11A to 11D sequentially illustrate a procedure of forming the barrier rib of the plasma display panel according to the second embodiment of the present invention.

As shown in FIG. 11A, a lower dielectric 630b is formed on the rear glass 600 having an electrode (not shown) mounted, and a barrier rib paste 610 having a predetermined thickness is formed on the lower dielectric 630b by using a printing method or a coating method.

A dry film resin (DFR) 611 is then formed on the barrier rib paste through a laminating process, and an exposure process aligning a photomask 612 having a predetermined pattern on the DFR and irradiation with a light such as vacuum ultraviolet rays is performed. In the photomask 612, a row direction pattern 612a for forming the row barrier rib and a column direction pattern 612b for forming the column barrier rib are different in width.

In other words, as shown, the width of the column direction pattern 612b is wider than the width of the row direction pattern 612a, and the width of the row direction pattern 612a at its central portion is narrower than the width of a peripheral portion. This is to generate a difference in height between the column barrier rib and the row barrier rib later formed, by differentiating the column direction pattern 612b and the row direction pattern 612a in width. Further, the reason for forming the row direction pattern 612a to have the smaller pattern width at its central portion is to provide the groove at the row barrier rib with the lower height, thereby improving the exhaust characteristic of the plasma display panel, and improving a discharge efficiency.

After the exposure process of the DFR 611, a developing process is performed as shown in FIG. 11B. In the developing process, the DFR 611 not exposed to the light (Hereinafter, referred to as “nonexposure region”) remains on the barrier rib paste 610, whereas the DFR 611 exposed to the light (Hereinafter, referred to as “exposure region”) is etched out.

Next, as shown in FIG. 11C, a sand blasting device 710 is positioned and driven over the barrier rib paste 610 and the DFR 611 that are subjected to the developing process, and sprays sand particles on the barrier rib paste 610. The barrier rib paste 610 is cut out due to sputtering of the sand particles whereas the paste 610 corresponding to the barrier rib is protected by a DFR 611 pattern. The DFR 611 is eliminated through the developing process. Accordingly, the column barrier rib and the row barrier rib having the same height are formed.

If isotropic etching is performed, the amount of etching is different due to a difference of the pattern widths, and the height of the row barrier rib 610a is less than the height of the column barrier rib 610b. Further, since the width of the row barrier rib of FIG. 11C at its top and central portion is narrower than the width of the top and peripheral portion, the groove 610a′ is provided at the top and central portion of the row barrier rib 610a as shown in FIG. 11D.

The row barrier rib and the column barrier rib manufactured as above partition the discharge cell of the plasma display panel.

The phosphor slurry is coated in the partitioned discharge cell. A phosphor coating method can also employ a conventional screen printing method but preferably, employs a direct patterning method. The direct patterning method refers to a method for directly coating the phosphor slurry in the discharge cell through a nozzle of an inkjet device or a nozzle of a dispensing device, and forming the phosphor layer, without forming a phosphor pattern by using an auxiliary means such as a pattern mask as in the screen printing method. Accordingly, the phosphor layer forming method can employ any methods as long as being the direct patterning method for directly coating the phosphor slurry in the discharge cell but preferably, is formed by using either the inkjet method or the dispensing method.

### Third Embodiment

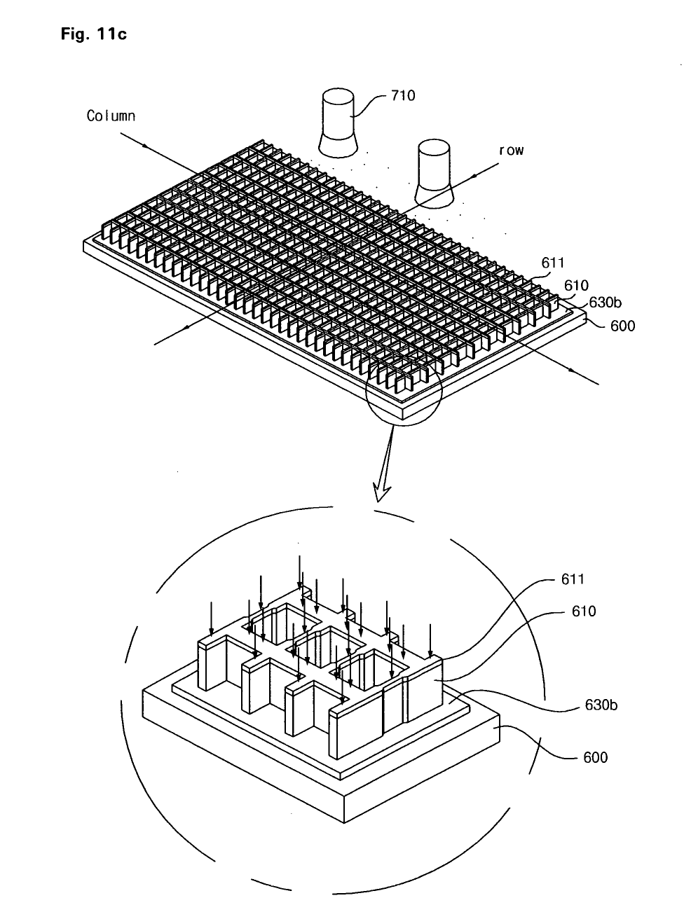

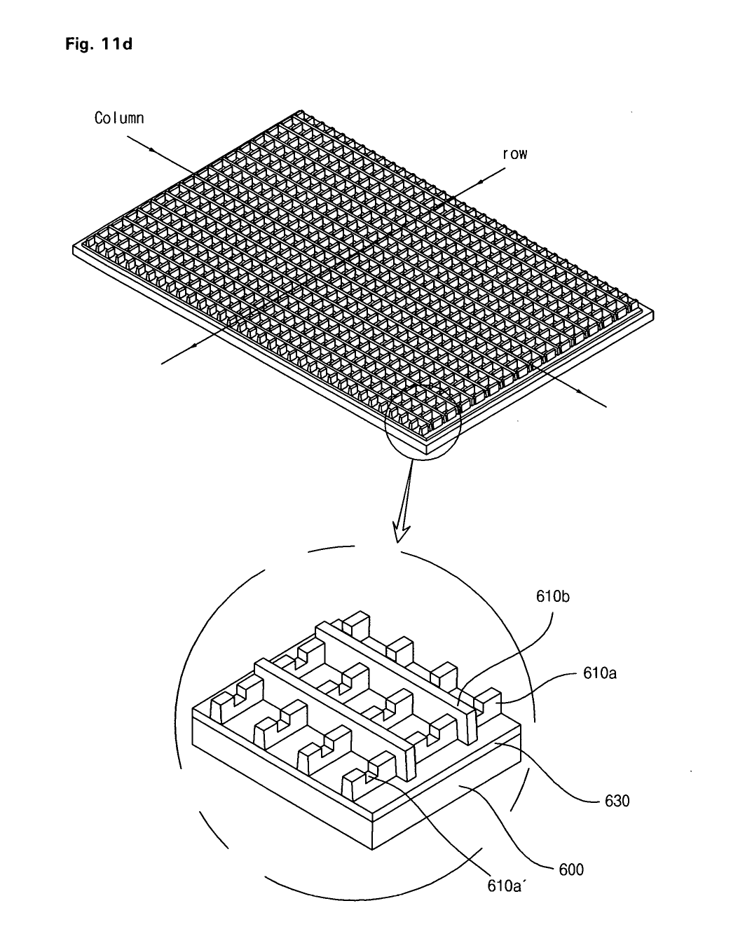

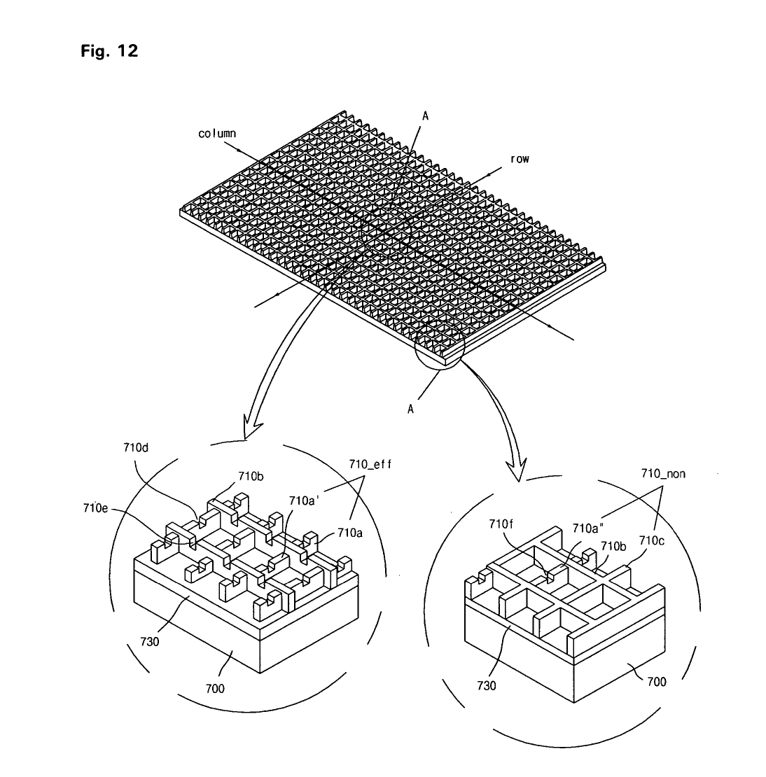

FIG. 12 is a perspective view illustrating a barrier rib structure of a plasma display panel according to the third embodiment of the present invention.

Before a description of FIG. 12, though not illustrated in the drawings, the inventive plasma display panel comprises a front panel being a display surface for displaying an image, and a rear panel being a rear surface and sealed to the front panel at a distance as in a conventional art.

The front panel comprises a sustain electrode pair arranged with a scan electrode and a sustain electrode each paired and formed on a front glass, and an upper dielectric layer is layered on the front glass having the scan electrode and the sustain electrode arranged in parallel, and limits a discharge electric current. A protective layer having oxide magnesium (MgO) deposited is formed on the upper dielectric layer, and prevents the upper dielectric layer from being damaged due to sputtering generated during plasma discharge and increases the emission efficiency of secondary electrons.

The rear panel comprises an address electrode arranged on a rear glass to intersect with the sustain electrode pair arranged in parallel on the front glass, and a lower dielectric layer is formed on the address electrode and accumulates wall charges. A barrier rib is formed on the lower dielectric layer, and partitions a discharge cell, and a phosphor layer is coated at a discharge cell space, and generates visible rays having either R (red), G (green), or B (blue) colors in discharge.

As shown in FIG. 12, the barrier rib formed at the above-constructed plasma display panel according to the present invention is a well type where the discharge cell is partitioned by surrounding a space by the row barrier rib 710a and the column barrier rib 710b on the lower dielectric 730 of the rear glass 700. In a discharge region (A) where an image is displayed and a nondischarge region (B) where the image is not displayed, the row barrier rib 710a and the column barrier rib 710b are formed to have different heights.

The row barrier rib 710a refers to a barrier rib for partitioning the discharge space where the same color phosphor, for example, a red only phosphor, a green only phosphor, or a blue only phosphor is coated, as one unit pixel, and the column barrier rib 710b refers to a barrier rib for separating and partitioning the red, green and blue phosphors as the unit pixel, respectively, in the discharge space where the red phosphor, the green phosphor, or the blue phosphor is coated.

In a description of the barrier rib in the discharge region (A), as shown in FIG. 12, the row barrier ribs 710_{—}eff and the column barrier rib 710b have different heights. The row barrier rib 710_{—}eff having the different height from the column barrier rib 710b has a lower height. The lower height of the row barrier rib 710_{—}eff is to prevent the color mixture of the phosphors resulting from that, when the phosphor is coated in the discharge cell partitioned as the row barrier rib 710_{—}eff and the column barrier rib 710b and the phosphor flows into an adjacent discharge cell due to a viscosity characteristic of the phosphor. That is, in the discharge space where the red phosphor, the green phosphor, or the blue phosphor is coated, the column barrier rib 710b for separating the red, green and blue phosphors, respectively, is formed to have a greater height than the row barrier rib 710_{—}eff. In other words, the row barrier rib 710_{—}eff is formed to have the lower height than the column barrier rib 710b.

The lower barrier rib 710_{—}eff is comprised of the row barrier rib 710a having a reference height and a row barrier rib 710a′ having a lower height than the reference height. The reference height is 70% to 80% of the height of the column barrier rib 710b. In a case where the row barrier rib 710a has a reference height of less than 70% of the column barrier rib 710b, it is difficult to form the row barrier rib 710a′ having a height lower than the reference height. In a case where the row barrier rib 710a has a height of more than 80% of the height of the column barrier rib 710b, color mixture of the phosphor cannot be sufficiently prevented. The row barrier rib 710a′ having the height lower than the reference height improves the exhaust characteristic.

The row barrier rib 710_{—}eff and the column barrier rib 710b in the discharge region have grooves 710d and 710e provided at their tops. The reason why the grooves 710d and 710e are provided at the top of the row barrier rib 710_{—}eff and the column barrier rib 710b is to prevent the color mixture of the phosphor and to improve the exhaust characteristic.

As shown in FIG. 12, some row barrier ribs 710c of row barrier ribs 710_{—}non in the nondischarge region (B) have the same height as the column barriers 710b. The height of the remaining row barrier ribs 710a″ is less than the height of the column barrier ribs 710b. The height of the row barrier ribs 710a″ is less than the height of the column barrier ribs 710b in the nondischarge region (B) improves the exhaust characteristic. A groove 710f is provided on the top of the row barrier rib 710a″. The groove 710f improves the exhaust characteristic.

The height of the row barrier rib 710c is almost similar to the height of the column barrier rib 710b in the nondischarge region (B) and therefore, an increase in a cohesive force with the glass occurs, thereby reducing noise. Further, the barrier ribs in the discharge region (A) and the nondischarge region (B) can be formed to have different heights, thereby preventing a foreign material generated in manufacturing the plasma display panel from being introduced into the discharge region (A). The height of the row barrier rib 710_{—}eff formed in the discharge region (A) is less height than the height of the column barrier rib 710b and has the groove 710d at its top, thereby preventing the phosphor from being coated in an undesired discharge cell and improving the exhaust characteristic.

A plasma display apparatus according to the present invention comprises the barrier rib of the above-described plasma display panel, and comprises a driver (not shown) for driving the plasma display panel.

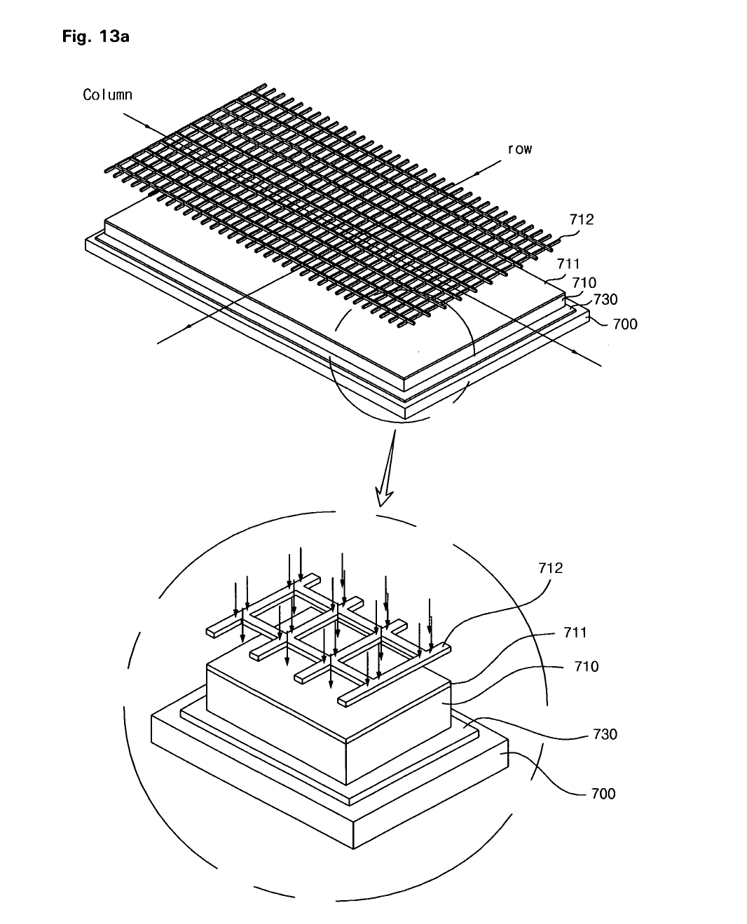

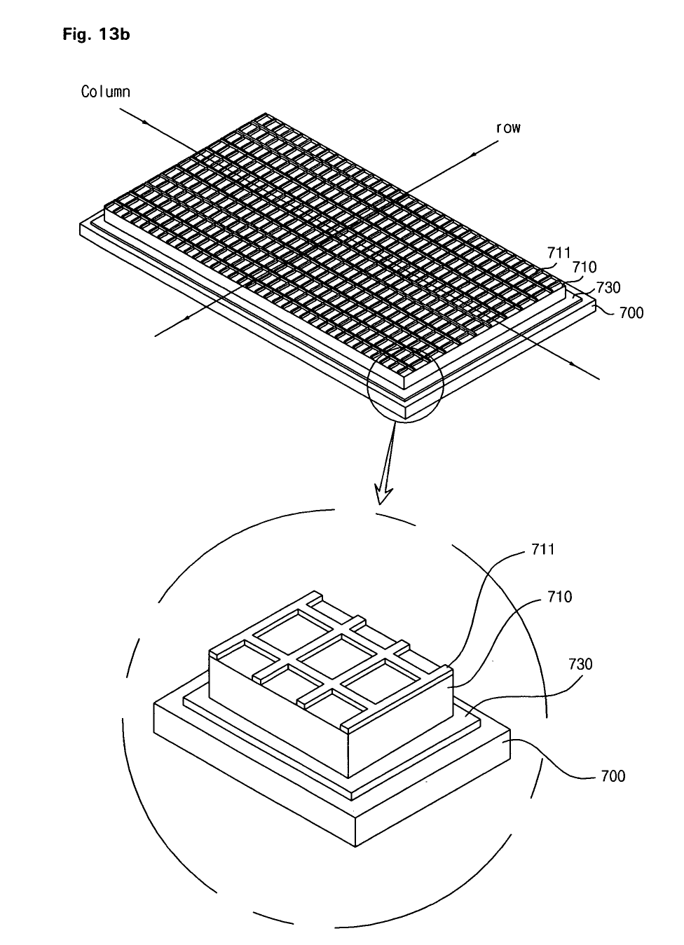

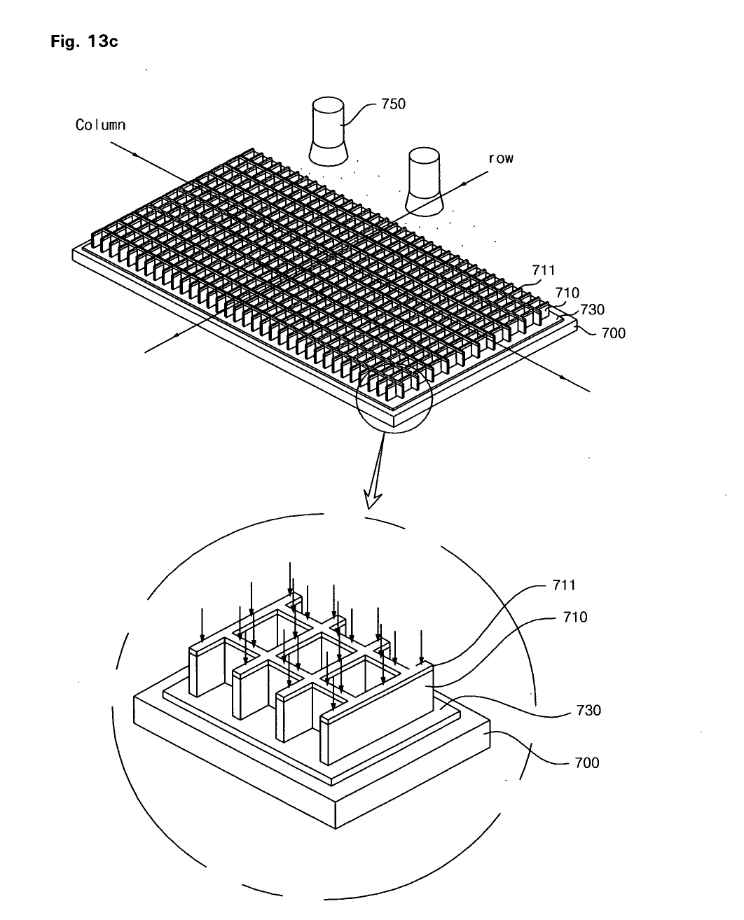

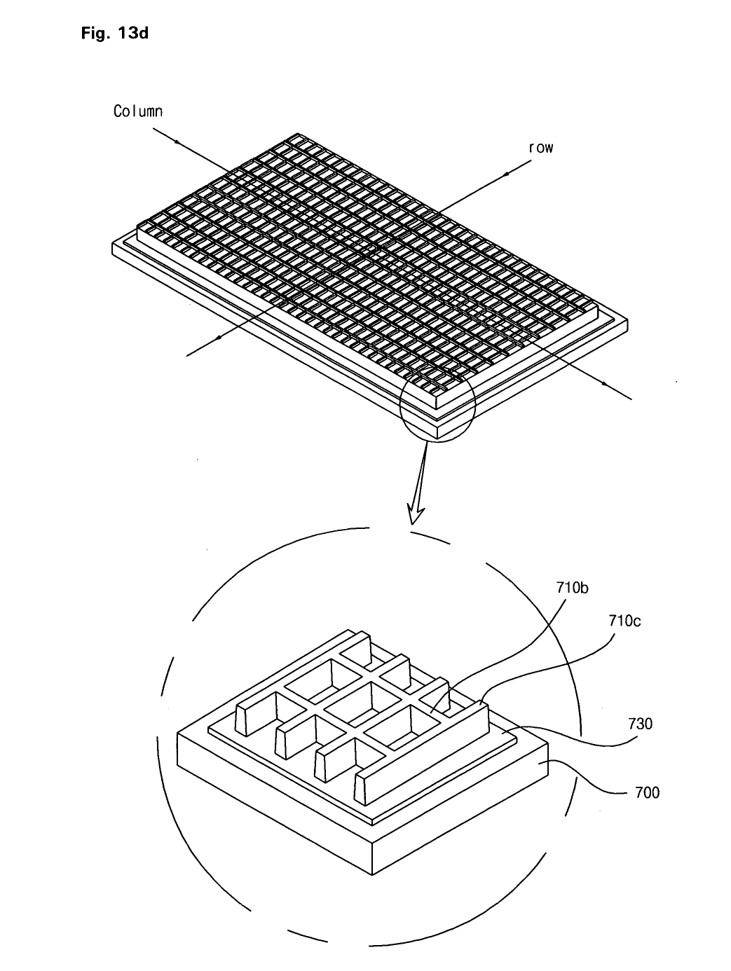

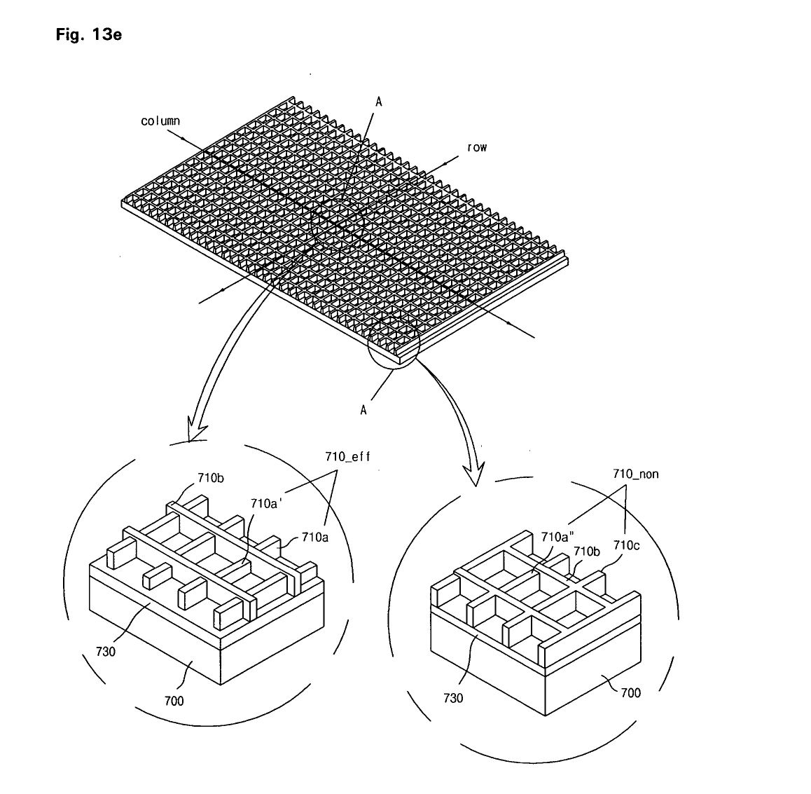

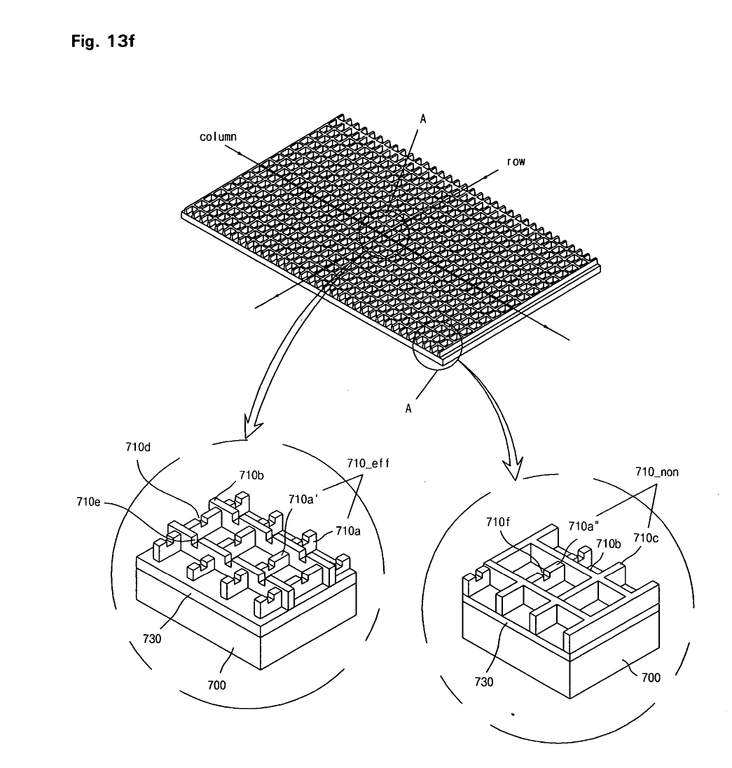

FIGS. 13A to 13F sequentially illustrate a procedure of forming the barrier rib of the plasma display panel according to the third embodiment of the present invention.

As shown in FIG. 13A, a lower dielectric 730 is formed on the rear glass 700 having an electrode (not shown) mounted, and a barrier rib paste 710 having a predetermined thickness is formed on the lower dielectric 730 by using a printing method or a coating method. The barrier rib paste 710 formed in the discharge region (A) of the panel and the barrier rib paste 710 formed in the nondischarge region (B) are the same in thickness.

A dry film resin (DFR) 711 is formed on the barrier rib paste through a laminating process and an exposure process aligns a photomask 612 having a predetermined pattern on the DFR and irradiation with a light such as vacuum ultraviolet rays occurs.

After the exposure process of the DFR 711, a developing process is performed as shown in FIG. 13B. In the developing process, the DFR 711 not exposed to the light (Hereinafter, referred to as “nonexposure region”) remains on the barrier rib paste 710, whereas the DFR 711 exposed to the light (Hereinafter, referred to as “exposure region”) is etched out.

Next, as shown in FIG. 13C, a sand blasting device 750 is positioned and driven over the barrier rib paste 710 and the DFR 711 that are subjected to the developing process, and sprays sand particles on the barrier rib paste 710. The barrier rib paste 710 is then cut out due to sputtering of the sand particles whereas the paste 710 corresponding to the barrier rib is protected by a DFR 711 pattern.

As shown in FIG. 13D, a peeling process is then performed for the barrier rib protected and formed by the DFR 711, to form the row barrier rib 710c and the column barrier rib 710b. The row barrier rib 710c and the column barrier rib 710b are formed to have the same height, that is, a first height.

As such, the manufacturing method of the barrier rib in FIGS. 13A to 13D is identically applied to the discharge region (A) and the nondischarge region (B).

As shown in FIGS. 13A to 13D, the row barrier rib 710c and the column barrier rib 710b having predetermined patterns are formed by forming and exposing the DFR on the top of the barrier rib paste. But unlike this, the row barrier rib 710c and the column barrier rib 710b can be also formed by containing and exposing a photosensitive material in the barrier rib paste itself.

As shown in FIG. 13E, the row barrier rib 710c of the discharge region (A) is etched at its top and the row barrier rib 710a is formed to have a second height lower than the first height. Accordingly, the row barrier rib 710a and the column barrier rib 710b are formed to have different heights in the discharge region (A), and the row barrier rib 710c and the column barrier rib 710b are formed to have the same height, that is, the first heights in the nondischarge region (B).

Next, as shown in FIG. 13F, the row barrier rib 710_{—}eff and any one of the column barrier ribs 710b in the discharge region (A) is etched at its top, thereby forming the grooves 710d and 710e. In the nondischarge region (B), the row barrier rib 710a″ having a height lower than the first height is etched at its top, thereby forming the groove 710f.

The row barrier rib and the column barrier rib manufactured in the above method partition the discharge cell of the plasma display panel.

The phosphor slurry is coated and the phosphor layer is formed in the partitioned discharge cell. A phosphor coating method can also employ a conventional screen printing method but preferably, employs a direct patterning method. The direct patterning method refers to a method for directly coating the phosphor slurry in the discharge cell through a nozzle of an inkjet device or a nozzle of a dispensing device, and forming the phosphor layer, without forming a phosphor pattern by using an auxiliary means such as a pattern mask as in the screen printing method. Accordingly, the phosphor layer forming method can employ any methods as long as being the direct patterning method for directly coating the phosphor slurry in the discharge cell but preferably, is formed by using either the inkjet method or the dispensing method.

A manufacturing method of the well-typed barrier rib having a step according to the present invention will be described in detail below.

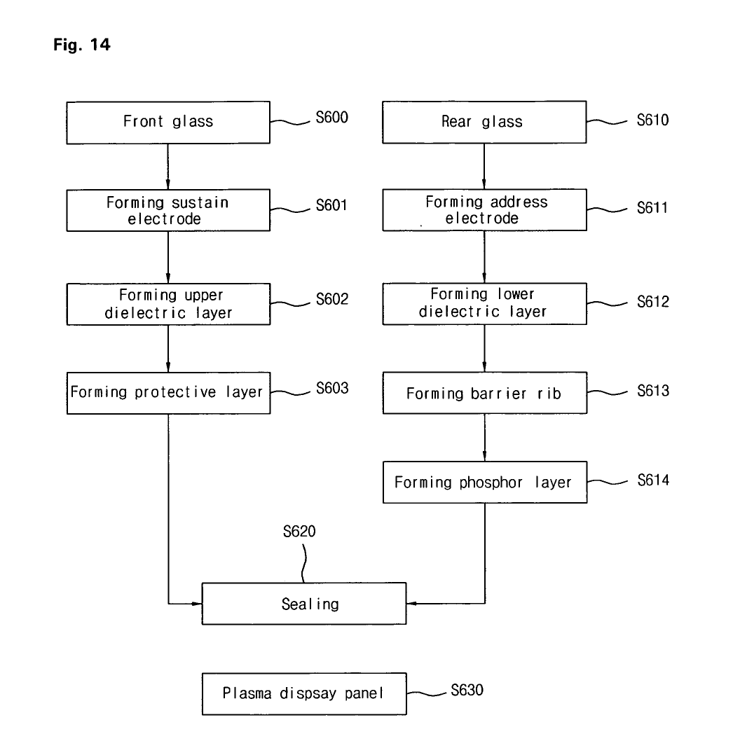

FIG. 14 sequentially illustrates a manufacturing method of a plasma display panel according to the present invention.

As shown in FIG. 14, the inventive manufacturing method of the plasma display panel comprises a manufacturing procedure of the front panel shown in a left side of FIG. 14, a manufacturing procedure of the rear panel shown in a right side of FIG. 14, and an assembly procedure comprising a sealing procedure and the like shown in a lower side of FIG. 14.

In a description of the manufacturing procedure of the front panel shown in the left side of FIG. 14, the front glass being a substrate is prepared (Step 600) and a plurality of sustain electrodes are formed on the front glass (Step 601). The upper dielectric layer for limiting the discharge current is then formed on the sustain electrode pair (Step 602) and the protective layer having oxide magnesium (MgO) deposited is formed on the upper dielectric layer, preventing the upper dielectric layer from being damaged due to sputtering generated in the plasma discharge and increasing the emission efficiency of the secondary electrons (Step 603).

In the description of the manufacturing procedure of the rear panel shown in the right side of FIG. 14, the rear glass being the substrate is prepared (Step 610), and the plurality of sustain electrodes are formed on the rear glass to intersect with and face the sustain electrode formed at the front panel (Step 611). Then, the lower dielectric layer for accumulating the wall charges is formed on the address electrode (Step 612), the barrier rib for partitioning the discharge cell is formed on the lower dielectric layer (Step 613) and the phosphor is coated and the phosphor layer is formed in the discharge cell partitioned by the barrier rib (Step 614).

The above manufactured front panel and rear panel are sealed with each other (Step 620) and the plasma display panel is formed (Step 630).

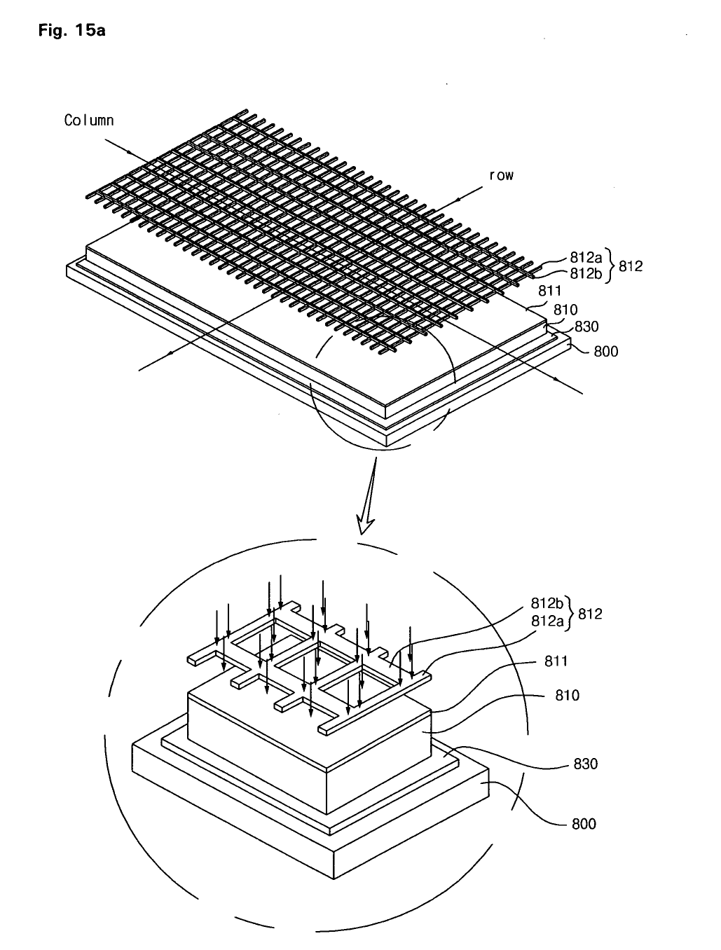

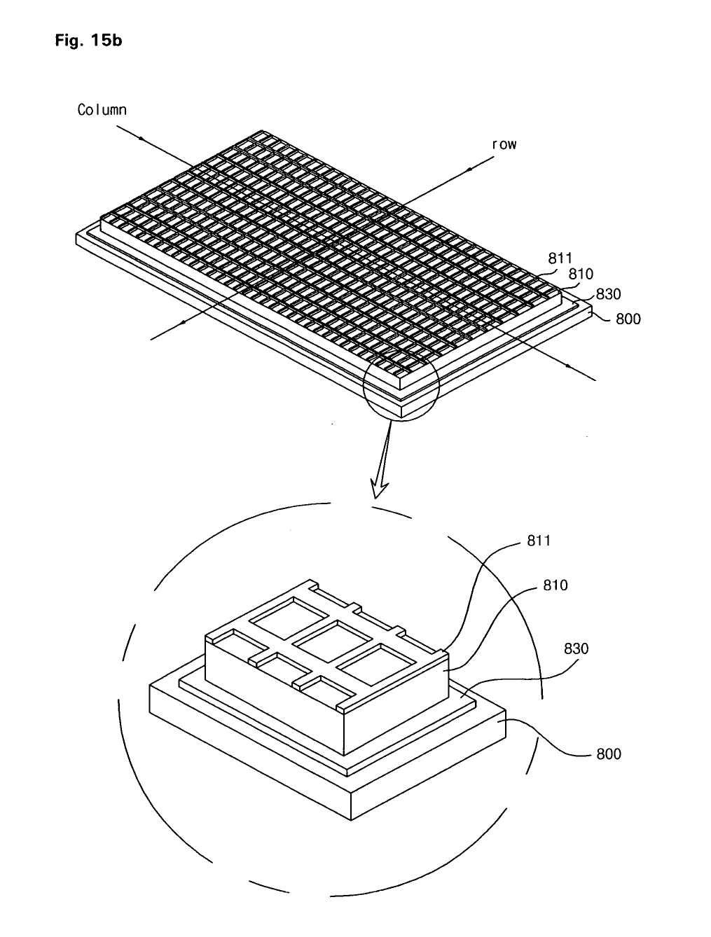

FIGS. 15A to 15C sequentially illustrate the manufacturing method of the barrier rib of the plasma display panel according to the present invention.

As shown in FIG. 15A, the lower dielectric 830 is formed on the rear glass 800 having the electrode (not shown) mounted, and the barrier rib paste 810 is formed to have a predetermined thickness on the lower dielectric 830 by using the printing method or the coating method.

Then, the DFR 811 is formed on the barrier rib paste 810 by using the laminating process, and the exposure process aligning the photomask 812 having the column direction pattern 812b greater in width than the row direction pattern 812a on the DFR and irradiation with a the light such as the vacuum ultraviolet rays occurs. The reason why the width of the column direction pattern 812b is wider than the width of the row direction pattern 812a is to provide the height difference between the row barrier rib and the column barrier rib to be formed later. Preferably, the column barrier rib is formed to have the greater height than the row barrier rib. This allows the column barrier rib to separate and partition the R, G, B phosphors as the unit pixel, respectively, thereby preventing the color mixture of the phosphors and improving the exhaust characteristic of the plasma display panel.

The column direction pattern 812b is two times to the three times the width of the row direction pattern 812a. In a case where the column direction pattern 812b is not twice the width of the row direction pattern 812a, it is not only difficult to significantly improve the exhaust characteristic of the plasma display panel but also the color mixture of the phosphor cannot be prevented. In a case where the width of the column direction pattern 812b is wider than the width of the row direction pattern 812a two times or three times, there is the danger of reducing the mechanical strength of the row barrier rib, thereby causing collapse.

As shown in FIG. 15B, after the exposure process of the DFR 811, the developing and etching processes are performed. In the developing process, the DFR 811 not exposed to the light (Hereinafter, referred to as “nonexposure region”) remains on the barrier rib paste 810, whereas the DFR 811 exposed to the light (Hereinafter, referred to as “exposure region”) is etched out.

After the developing process, if an isotropic etching is performed, the barrier rib paste will be etched less in the column direction pattern 812b having the greater pattern width than in the row direction pattern 812a having the smaller pattern width. And the column barrier rib is formed to have the greater height than the row barrier rib.

As shown in FIG. 15C, a peeling process is performed for the barrier rib 810 protected and formed by the DFR 811.

As shown in FIGS. 15A to 15C, the row barrier rib and the column barrier rib can be formed and exposed on the barrier rib paste to have different heights. The row barrier rib and the column barrier rib can be also formed to have different heights by containing and exposing a photosensitive material in the barrier rib paste itself, or can be formed by using the green sheet.

In the case where the row barrier rib and the column barrier rib are formed by using the green sheet to have different heights, the barrier rib can be uniformly controlled in thickness, thereby improving the plasma display panel in uniformity. The green sheet of the plasma display panel according to the present invention will be described as follows.

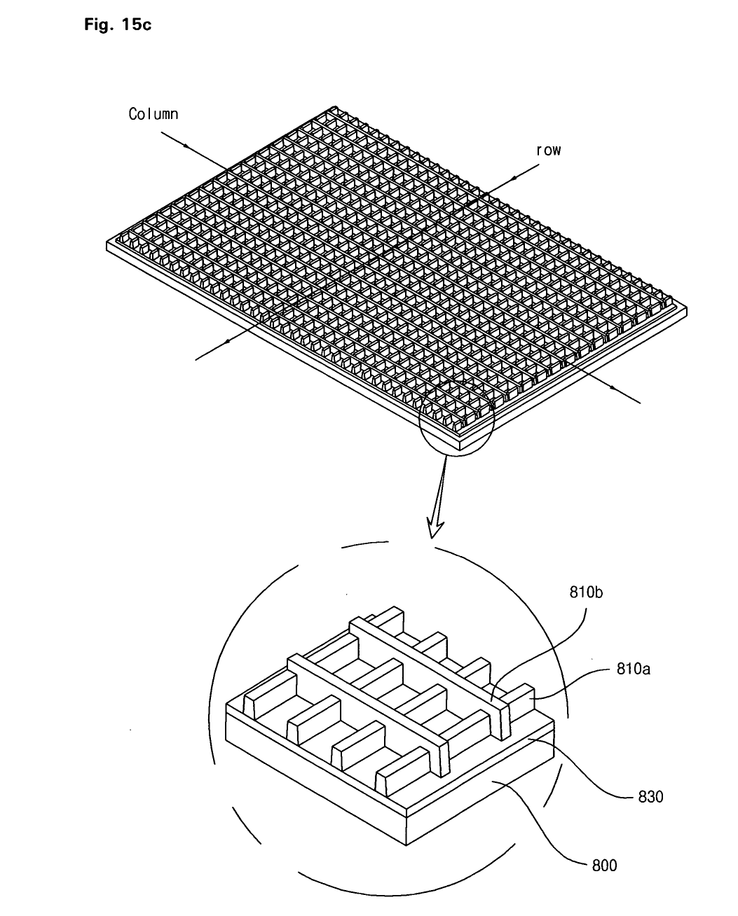

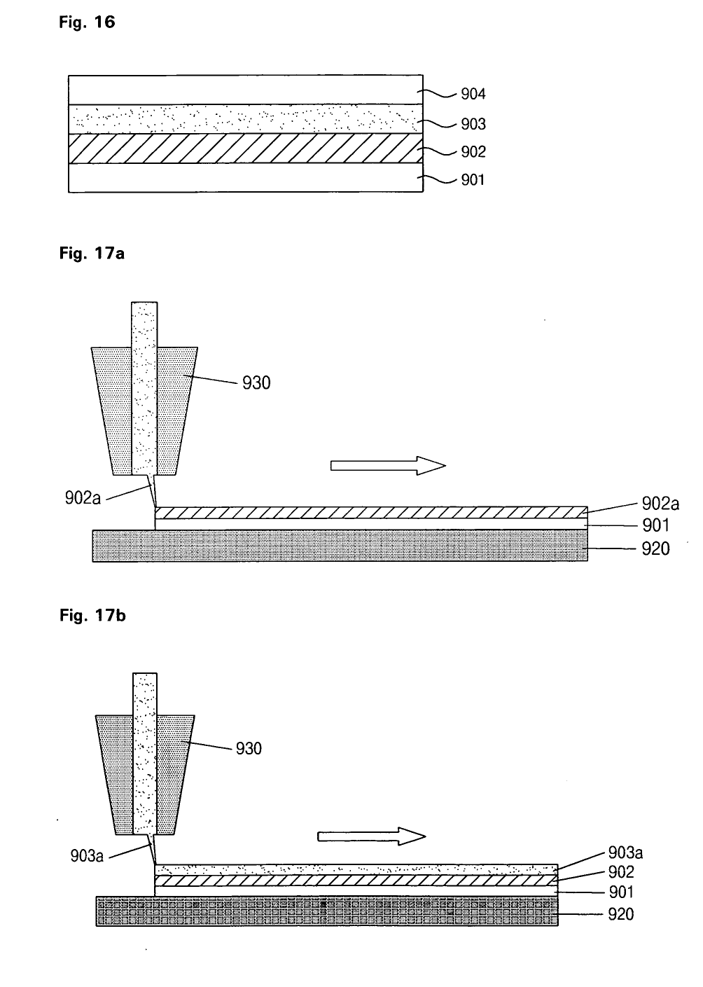

FIG. 16 illustrates the green sheet of the plasma display panel according to an embodiment of the present invention.

As shown in FIG. 16, an underlying base film 901 is formed, a first dry film 902 is formed on the base film 901, a second dry film 903 is formed of a material having a different dielectric constant from the first dry film 902, and a cover film 904 is formed on the second dry film 903. The reason why the first and second dry films 902 and 903 are formed of materials having different constants is to reduce power consumption of the plasma display panel. The first dry film 902 is formed of a material having a darker color than the second dry film 903. This is because the first dry film is a dry film for forming the barrier rib positioned closely to the display surface of the panel and therefore, if the first dry film is formed of the dark colored material, the plasma display panel's contrast improves. FIG. 16 illustrates the two dry film layers. However, the dry film can be also formed as one layer or three or more layers.

A procedure of forming the green sheet having the above structure will be described as follows.

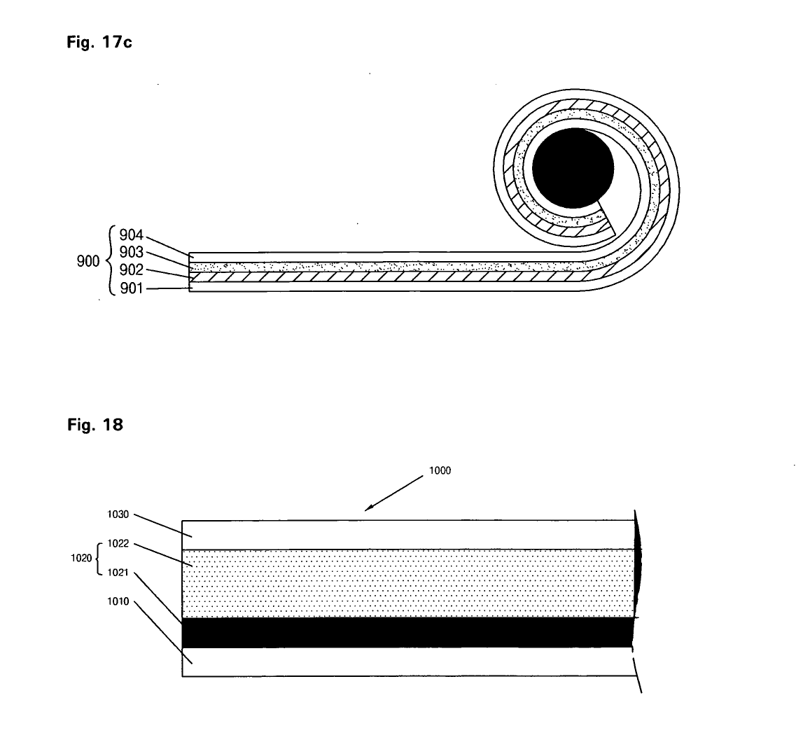

FIGS. 17A to 17C illustrate a manufacturing method of the barrier rib green sheet according to an embodiment of the present invention.

First referring to FIG. 17A, the first dry film 902 for forming the barrier rib is coated to have a predetermined thickness on the base film 901 that is formed of polyethylene terephthalate (PET) on a conveyer belt 920 by using a barrier rib first slurry 902a.

Then, as shown in FIG. 17B, the first slurry 902a coated on the base film 901 is dried to form the first dry film 902. Next, a second slurry 903a is coated and dried on the resultant to form the second dry film 903. The first and second slurries 902a and the 903a are formed of materials having the different dielectric constants. This is because if the first and second slurries 902a and 903a are formed of the materials having the different dielectric constants, the power consumption is reduced in driving the plasma display panel. The color of the first slurry 902a is darker than the color of the second slurry 903a so as to improve the contrast of the plasma display panel because the first dry film is formed by using the first slurry and the barrier rib positioned closely to the display surface is formed by using the first dry film.

As shown in FIG. 17C, if the cover film 904 covers the second dry film 903 and is manufactured in a roll format, a final green sheet 900 is completed.

In the case where the barrier ribs are formed by using the green sheet, the barrier ribs are formed to have the different heights in the method aforementioned in FIGS. 15A to 15C.

The inventive plasma display panel is characterized by comprising the barrier ribs formed to have the different heights by performing a one-time exposure and etching process, with row direction and column direction pattern masks differentiated in width, by using the barrier rib paste or the green sheet.

By forming the barrier ribs having different heights through the one-time exposure and etching process with row direction and column direction pattern masks differentiated in width, the manufacturing process of the barrier rib is reduced in number of steps and the manufacturing costs of the plasma display panel are reduced.

With the green sheet used in the manufacturing method of the plasma display panel, the barrier rib film can be uniformly controlled, thereby improving the uniformity of the plasma display panel.

The green sheet can also additionally comprise the black color layer. Its detailed description will be made with reference to the drawings.

FIG. 18 illustrates a green sheet of a plasma display panel according to another embodiment of the present invention.

As shown in FIG. 18, the inventive barrier rib green sheet 1000 comprises a base film 1010, a barrier rib dry film 1020 formed on the base film 1010, and a cover film 1030 formed on the barrier rib dry film 1020.

The base film 1010 is a film formed of polyethylene terephthalate (PET). The base film 1010 is a basis for forming the barrier rib dry film 1020. The base film 1010 functions as a protective layer protecting the dry film 1020.

The barrier rib dry film 1020 is a film layer substantially formed in the plasma display panel, and is later used as the barrier rib of the plasma display panel.

The inventive barrier rib dry film 1020 comprises a black color layer 1021 and a barrier rib layer 1022. Accordingly, when the plasma display panel is manufactured, a separate process of forming the black color layer is not required and therefore, the manufacturing process steps can be reduced.

The black color layer 1021 is comprised in the dry film 1020, thereby controlling a uniform thickness more easily than when the plasma display panel where the black color layer is directly formed. Accordingly, luminance deviation and deviation of a driving characteristic of the plasma display panel can be prevented.

The black color layer 1021 is formed to have a thickness of 0.1 μm to 10 μm. The thickness of 0.1 μm is the minimal thickness for providing a light shielding function and a function of improving a color purity and the contrast. The thickness of 10 μm is the maximal thickness for preventing reduction of the contrast caused by absorbing internal light, which is generated in the discharge, in the black color layer from the plasma display panel.

The cover film 1030 is formed on the dry film 1020, and a film layer having the function of protecting the dry film 1020.

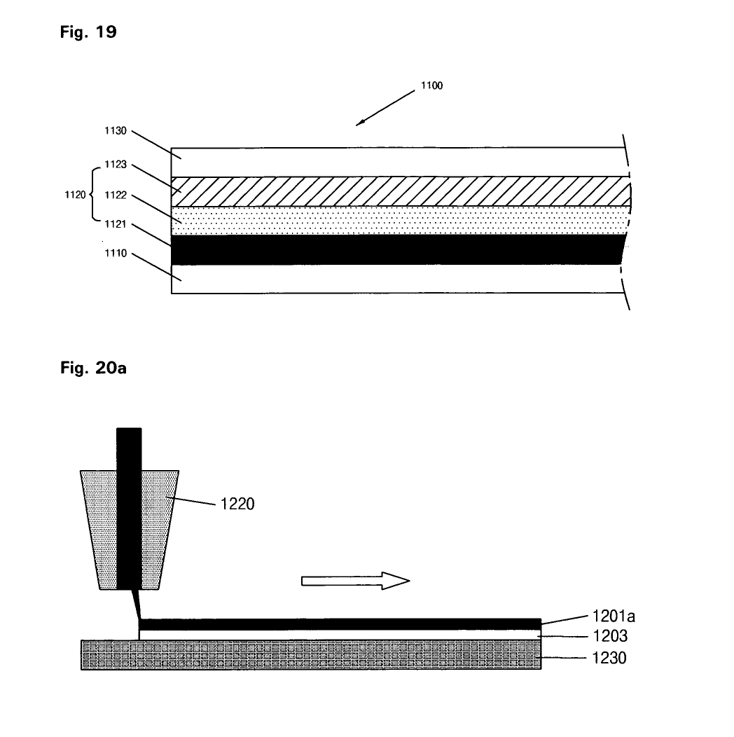

FIG. 19 illustrates a green sheet of a plasma display panel according to a further another embodiment of the present invention.

As shown in FIG. 19, the inventive barrier rib green sheet 1100 of a modified format comprises a base film 1110, a barrier rib dry film 1120 formed on the base film 1110, and a cover film 1130 formed on the barrier rib dry film 1120.

The dry film 1120 comprises a black color layer 1121, and comprises a plurality of barrier rib layers 1122 and 1123 formed of different materials. The plurality of barrier rib layers, that is, the first and second barrier rib layers 1122 and 1123 can be formed of materials having different permittivities, thereby reducing the power consumption of the plasma display panel.

The barrier rib of the plasma display panel absorbs a leakage current generated in plasma discharge, and acts as a capacitor. If the first barrier rib layer 1122 is formed of the material having a lower permittivity than the second barrier rib layer 1123, the barrier rib formed by using the first barrier rib layer 1122 has a relatively low permittivity, thereby reducing the capacitance, and finally reducing the power consumption of the plasma display panel.

In the further another embodiment of the present invention, the plurality of barrier rib layers having the different permittivities is exemplified, but the dry film 1120 can be formed with the barrier rib layers differentiated in material, according to another factor being capable of influencing the driving of the plasma display panel. Further, the barrier rib layer can be varied in number of layers or thickness of the layers.

The base film 1110 and the cover film 1130 have the same functions as the base film 1010 and the cover film 1030 of FIG. 18 and therefore, their description will be omitted.

The black color layer is formed as either an uppermost layer or a lowermost layer of the barrier rib dry film. This is determined depending on whether either the front or rear substrates is used as the display surface. That is, the black color layer can be formed at a side of the display surface, thereby providing the light shielding function and the function of improving the color purity and the contrast.

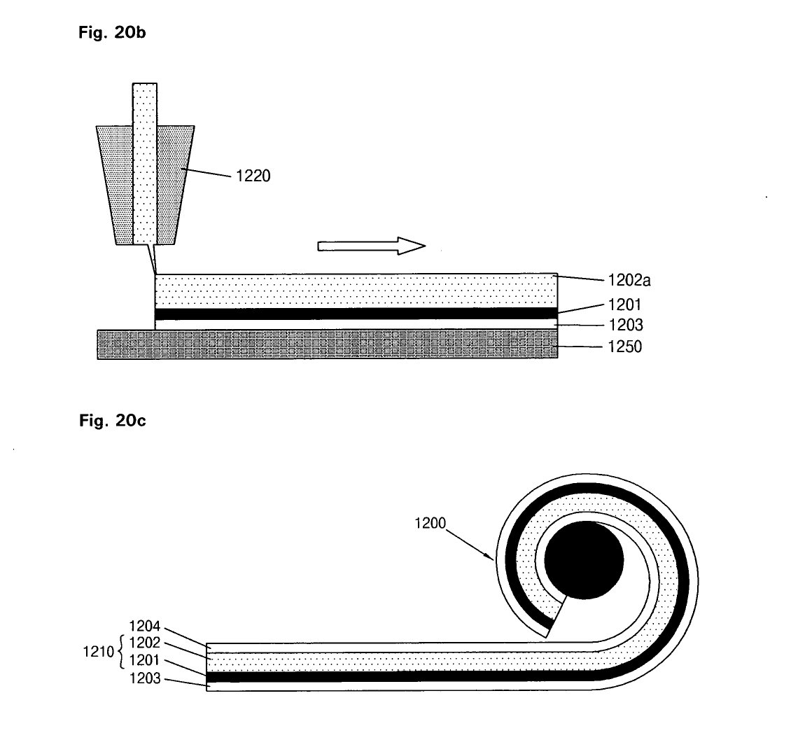

FIGS. 20A to 20C illustrate a method of forming a dielectric green sheet according to another embodiment of the present invention.

As shown in FIG. 20A, in a coater 1220 comprising a black color layer slurry 1201a obtained by mixing a black-color glass pigment having a low melting point, an organic solution, a bonding agent, and an additive, slurry is coated at a predetermined speed to have a predetermined thickness on a base film 1203 that is formed of PET on a conveyor belt 1230. The black color slurry 1201a formed on the base film passes through a dry section (not shown), thereby forming the black color layer of the dry film.

As shown in FIG. 20B, in a coater 1240 comprising a barrier rib layer slurry 1202a obtained by mixing a black-color glass pigment having a low melting point, an organic solution, a bonding agent, and an additive, slurry is coated at a predetermined speed to have a predetermined thickness on a block color layer 1201 of the dry film formed on a conveyor belt 1250. The barrier rib layer slurry 1202a formed on the black color layer 1201 passes through a dry section (not shown), thereby forming the barrier rib layer of the dry film.

As shown in FIG. 20C, a cover film 1204 is formed on the barrier rib dry film 1210 formed on the base film 1203 and then, is manufactured in a roll format, thereby forming a final barrier rib green sheet 1200.

In another embodiment of the present invention, the barrier rib green sheet 1200 can be used to form either the front substrate or the rear substrate of the plasma display panel. That is, the barrier rib is selectively formed at either the front substrate or the rear substrate according to a structure of the plasma display panel. In the plasma display panel, the barrier can be defined to form the unit cell between the front substrate and the rear substrate.

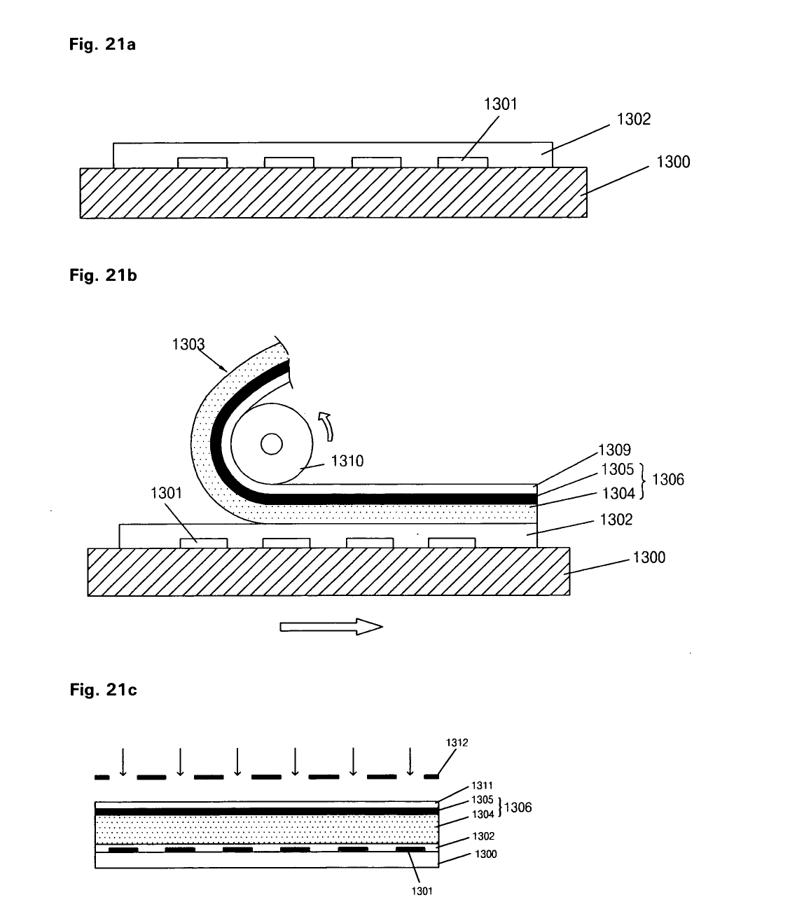

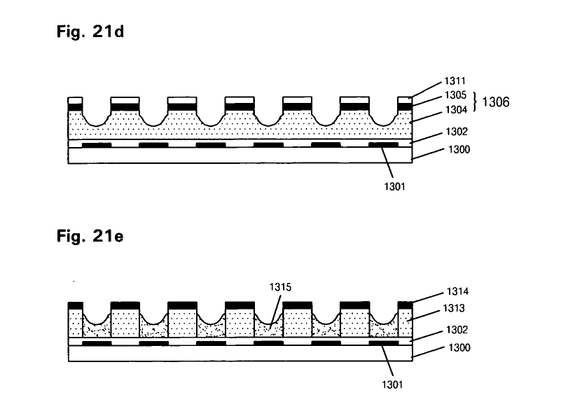

FIGS. 21A to 21E illustrate a procedure of manufacturing the rear substrate of the plasma display panel by using the green sheet according to another embodiment of the present invention.

Referring to FIG. 21A, a dielectric 1302 is formed on a glass 1300 on which an address electrode 1301 is mounted.

Referring to FIG. 21B, a barrier rib dry film 1306 comprising a barrier rib layer 1304 and a black color layer 1305 is formed on the dielectric 1302 by using the barrier rib green sheet 1303. In its detailed description, a cover film (not shown) is removed from the barrier rib green sheet 1303 by using a cover film removing roller (not shown) and concurrently, the barrier rib dry film 1306 and the base film 1309 are laminated on the dielectric 1302 by using a lamination roller 1310, and then the base film 1309 is removed.

Referring to FIG. 21C, a predetermined photoresist film, for example, a dry film resin (DFR) 1311 is formed on the barrier rib dry film 1306 by using a method such as a laminating process. A photomask 1311 is aligned on the DRF 1311, an exposure process is performed by using the photomask 1311, and then, a developing process is performed.

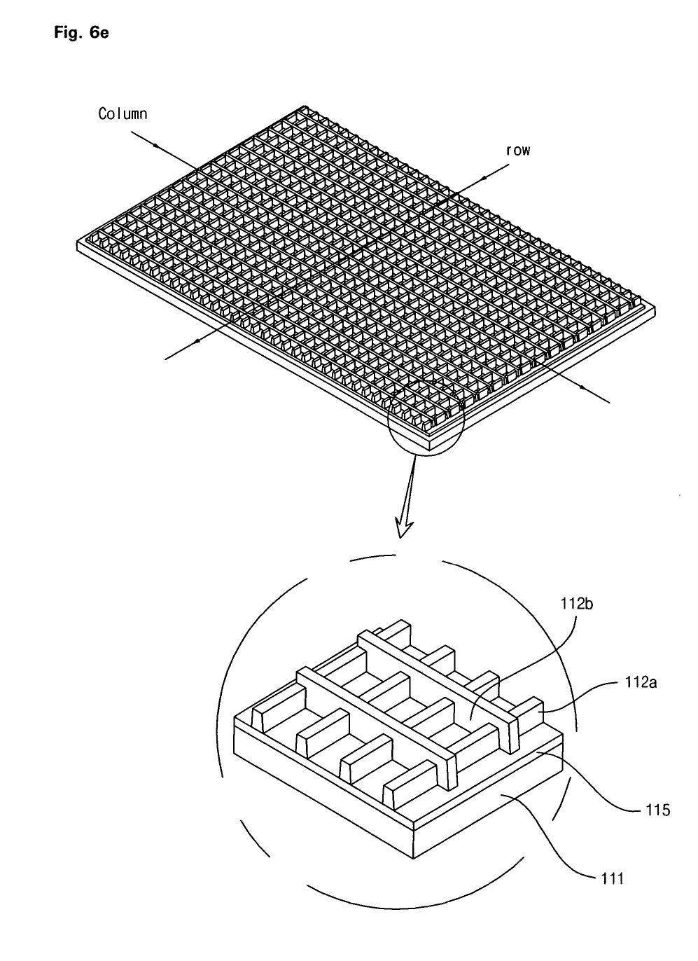

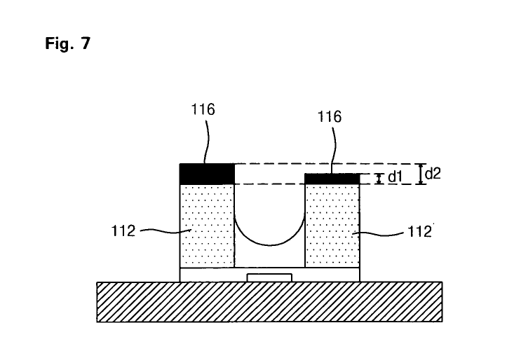

By the developing process, the DFR 1311 exposed to the light (Hereinafter, referred to as “exposure region”) reamains on the barrier rib dry film 1306, whereas the DFR 1311 not exposed to the light (Hereinafter, referred to as “nonexposure region”) is etched out, thereby providing a shape as shown in FIG. 7D.

Referring to FIG. 21D, an etching device (not shown) sprays etchant on the barrier rib dry film 1306 and the DFR 1311 that are subjected to the developing process. The barrier rib layer 1304 of the dry film and the black layer 1305 of the dry film are protected by the DFR 1311 pattern, and the barrier rib dry film 1306 not having the DFR 1311 pattern is etched.

Referring to FIG. 21E, the barrier rib 1313 and the black color 1314 are formed by the etching process and then, a phosphor 1315 is formed in the discharge space between the barrier ribs, thereby completing the rear substrate.

As described above, the black color layer can be comprised in the dry film of the barrier rib green sheet, thereby forming the black color layer having the uniform thickness when the plasma display panel is manufactured. Further, when the dry film is formed, the black color layer is controlled in thickness, thereby easily controlling the thickness of the black color layer of the plasma display panel manufactured. Accordingly, the luminance deviation and the deviation of the driving characteristic is suppressed, and the manufacturing process of the plasma display panel is simplified.

The invention being thus described may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display panel comprising:
a row barrier rib partitioning adjacent cells having the same phosphor coating, and having a groove at its top; and
a column barrier rib intersecting with the row barrier rib.

2. The panel of claim 2, wherein the row barrier rib has at least one groove at a top thereof.

3. The panel of claim 1, wherein the groove has a width of 5% to 90% of a top width of the row barrier rib.

4. The panel of claim 1, wherein the groove has a width of 10 μm to 200 μm.

5. A plasma display apparatus comprising:
a row barrier rib partitioning adjacent cells having the same phosphor coating, and having a groove at its top; and
a column barrier rib intersecting with the row barrier rib.

6. A method of manufacturing a plasma display panel having a discharge cell partitioned by a row barrier rib and a column barrier rib, and a phosphor coating in the discharge cell, the method comprising the steps of:
forming the row barrier rib and the column barrier rib along a pattern of the row barrier rib and a pattern of the column barrier rib; and
etching a portion of a top of the row barrier rib, and providing a groove at the top of the row barrier rib.

7. The method of claim 6, wherein the etching is performed by using either an etching method or a sand blasting method.

8. The method of claim 6, wherein the phosphor is formed by using a direct patterning method.

9. The method of claim 8, wherein the direct patterning method is either an inkjet method or a dispensing method.

10. The method of claim 6, wherein the row barrier rib and the column barrier rib have the same height.

11. A plasma display panel, wherein a row barrier rib and a column barrier rib having heights different from each other partition a discharge cell, and
wherein the row barrier rib or the column barrier rib having the lower height has a groove at its top.

12. The panel of claim 11, wherein the groove is positioned at the top and center of the row barrier rib or the column barrier rib having the lower height.

13. The panel of claim 12, wherein the row barrier rib has the lower height.

14. The panel of claim 11, wherein the groove has a width of 5% to 90% of the top width of the row barrier rib.

15. The panel of claim 11, wherein the groove has a width of 10 μm to 200 μm.

16. A plasma display apparatus, wherein a row barrier rib and a column barrier rib having heights different from each other partition a discharge cell, and
wherein the row barrier rib or the column barrier rib has a lower height has a groove at its top.

17. A method of manufacturing a plasma display panel having a phosphor coated in a discharge cell, the method comprising the steps of:
coating a barrier rib paste on a dielectric formed on a glass;
placing a photomask having a predetermined pattern on the barrier rib paste, and forming a row barrier rib pattern and a column barrier rib pattern partitioning the discharge cell;
etching the barrier rib paste along the row barrier rib pattern and the column barrier rib pattern and forming a row barrier rib and a column barrier rib having heights different from each other; and
providing a groove at a top of the row barrier rib or the column barrier rib having the lower height.

18. The method of claim 17, wherein the height of the row barrier rib less than the height of the column barrier rib.

19. The method of claim 17, wherein the width of the pattern of the photomask for the forming the row barrier rib is narrower than the width of the pattern of the photomask for forming column barrier rib, and
wherein the width of a portion of the pattern of the row barrier rib is narrower than the remaining portion of the pattern of the row barrier rib.

20. The method of claim 19, wherein the width of the pattern of a central portion of the row barrier rib is smaller than the width of the pattern of the remaining portion of the row barrier rib.

21. The method of claim 17, wherein the phosphor is formed by using a direct patterning method.

22. The method of claim 21, wherein the direct patterning method is either an inkjet method or a dispensing method.

23. The method of claim 17, wherein the etching is isotropic etching.

24. A plasma display panel, wherein row barrier ribs and column barrier ribs are formed to have heights different from each other in a discharge region of the panel, and
wherein some of the row barrier ribs have the same heights as the heights of the column barrier ribs in a nondischarge region of the panel.

25. The panel of claim 24, wherein the row barrier rib has a lower height than the column barrier rib in the discharge region of the panel.

26. The panel of claim 25, wherein the row barrier rib has a height of 70% to 80% of a height of the column barrier rib.

27. The panel of claim 25, wherein at least one of the row barrier ribs has a lower height than the remaining row barrier ribs.

28. The panel of claim 24, wherein a groove is provided at a top of at least one of the row barriers formed in the discharge region of the panel.

29. The panel of claim 24, wherein a groove is provided at a top of at least one of the column barriers formed in the discharge region of the panel.

30. The panel of claim 24, wherein a groove is provided at a top of at least one of the column barriers formed in the nondischarge region of the panel.

31. The panel of claim 24, wherein heights of one or more of the row barrier ribs formed in the nondischarge region of the panel is lower than the heights of the column barrier ribs, wherein a groove is provided at each top of the one or more row barrier ribs.

32. A plasma display apparatus, wherein a row barrier rib and a column barrier rib are formed to have heights different from each other in a discharge region of a plasma display panel, and
wherein some of the row barrier ribs have the same height as the column barrier ribs in a nondischarge region of the panel.

33. A method of manufacturing a plasma display panel having phosphors coated in discharge cells of a discharge region and a nondischarge region, the method comprising the steps of:
coating a barrier rib paste on a dielectric formed on a glass of the discharge region and the nondischarge region;
forming row barrier ribs and column barrier ribs having first heights through etching the barrier rib paste along a predetermined pattern; and
etching each top of one or more of the row barrier ribs formed in the discharge region for forming the row barrier ribs having second heights lower than the first heights.

34. The method of claim 33, wherein each top of at least one of the one or more row barrier ribs having the second heights is etched.

35. The method of claim 33, wherein at least one of the row barrier ribs and the column barrier ribs in the discharge region is partially etched to have a groove at its top.

36. The method of claim 34, wherein each top of the row barrier ribs having the lower heights than the second heights is partially etched to have a groove at its top.

37. The method of claim 33, further comprising the step of: etching each top of at least one of the row barrier ribs of the nondischarge region.

38. The method of claim 37, wherein the row barrier rib is partially etched to have a groove at its top.

39. The method of claim 33, wherein the phosphor is formed by using a direct patterning method.

40. The method of claim 39, wherein the direct patterning method is either an inkjet method or a dispensing method.

41. A method of manufacturing a plasma display panel, the method comprising the steps of:
forming a coating film on a dielectric formed on a glass;
placing a photomask having a row direction pattern and a column direction pattern having widths different from each other, on the coating film, and forming a row barrier rib pattern and a column barrier rib pattern; and
etching the barrier rib paste along the pattern of the photomask for forming a row barrier rib and a column barrier rib having heights different from each other.

42. The method of claim 41, wherein the column direction pattern has a greater width than the row direction pattern.

43. The method of claim 42, wherein the column direction pattern is two times to three times of the width of the row direction pattern.

44. The method of claim 41, wherein the column barrier rib has a greater height than the row barrier rib.

45. The method of claim 41, wherein the coating film is formed of either a barrier rib paste or a green sheet.

46. The method of claim 45, wherein a dry film of the green sheet is formed to have a plurality of layers.

47. The method of claim 46, wherein the dry film is formed to have the plurality of layers having dielectric constants different from one another.

48. The method of claim 46, wherein the dry film layer forming a barrier rib near to a display surface of the panel, among the plurality of dry film layers, has a dark color.

49. A plasma display panel comprising a barrier rib formed in a manufacturing method claimed in claim 41.

50. A barrier rib green sheet of a plasma display panel, the sheet comprising:
a base film;
a barrier rib dry film having a black color layer and a barrier rib layer formed on the base film; and
a cover film formed on the barrier rib dry film.

51. The sheet of claim 50, wherein the black color layer has a thickness of 0.1 μm to 10 μm.

52. The sheet of claim 50, wherein the barrier rib layer is formed to have a plurality of layers having materials different from one another.

53. The sheet of claim 52, wherein the plurality of layers is different from one another in permittivity.

54. The sheet of claim 50, wherein the black color layer is either an uppermost layer or a lowermost layer of the barrier rib dry film.

55. A plasma display panel, wherein a barrier rib is formed at either a front substrate or a rear substrate by using a barrier rib green sheet of a plasma display panel claimed in claim 50.
